(19) United States
(12) Patent Application Publication
(10) Pub. No.: US 2012/0110931 A1
(43) Pub. Date: May 10, 2012

(54) ISOLATION MOUNT AND METHODS THEREFOR

(76) Inventors: Patrina Eiffert, Golden, CO (US); Annett Eiffert, Fair Oaks, CA (US)

(21) Appl. No.: 13/285,942

(22) Filed: Oct. 31, 2011

Related U.S. Application Data
(63) Continuation-in-part of application No. 12/886,973, filed on Sep. 21, 2010.
Application No. 12/886,973 is a continuation-in-part of application No. 11/933,902, filed on Nov. 1, 2007, now Pat. No. 7,810,286.

(51) Int. Cl. E04D 13/18; B23P 17/04; E04B 1/38

(52) U.S. Cl. 52/173.3; 52/588.1; 29/428

(57) ABSTRACT

An isolation mount comprises a hollow wedge shaped shell having an upper sloped surface and at least three sidewalls extending therefrom to join a surrounding flange. The wedge shaped shell is thermoformed from a rigid plastic material. The upper sloped surface may include stiffening ribs and the shell may include a ballast recess adapted to contain roofing ballast. The inner perimeter portion of a skirt membrane is secured to the surrounding flange and an outer perimeter portion of the skirt extends away from the surrounding flange and is securable to a surface. The inner perimeter portion may be sealed to the surrounding flange. The inner perimeter portion defines a skirt membrane opening leading into a hollow region of the shell such that multiple isolation mounts may be stacked together.

### CROSS-REFERENCE TO RELATED APPLICATIONS

This application is a continuation-in-part of U.S. patent application Ser. No. 12/886,973, filed Sep. 21, 2010, which is a continuation-in-part of U.S. patent application Ser. No. 11/933,902, filed Nov. 1, 2007, now U.S. Pat. No. 7,810,286, the disclosures of which are hereby incorporated by reference in their entireties.

### TECHNICAL FIELD

The traditional roof assembly provides protection to the building and its contents from the effects of weather. The technology of the present application relates to a roofing assembly that incorporates solar panels as well as provides protection to the building and its contents from the effects of weather.

### BACKGROUND

Commercial flat and low-sloped roofing systems provide moisture resistance, thermal resistance (R-value) and dimensional stability as part of the building envelope.

Flat and low-slope roof membranes fall into two main materials categories a) polymer based and b) bitumen based. Within polymer based low-slope roof systems there are two major types: Thermosets (TS), including Ethylene Propylene Diene Monomer (EPDM) and Chlorosulfonated Polyethylene (CSPE), and Thermoplastics (TP), including Poly Vinyl Chloride (PVC), Thermoplastic Polyolefin (TPO), Chlorinated Polyethylene (CPE) and Keytone Ethylene Ester (KEE). Within the bitumen based low-slope roof systems there are two categories: Built-up Roofing (BUR) including Asphalt and Coal Tar and Modified Bitumen (Mod. Bit.) including Atactic polypropylene (APP) and Styrene-Butadiene Styrene (SBS).

Membrane roof materials and systems are designed to meet the requirements of the building in specific climatic conditions and are specified based on the cost, long-term weatherability, resistance to stress caused by expansion and contraction from fluctuations in temperature, ultraviolet light resistance, solar reflectance and emittance, tensile strength, water and fire resistance, wind uplift, elongation and thermal expansion, dynamic puncture resistance and resistance to rooftop contaminants such as acid rain and air pollution. Exposure to extreme environments, ultraviolet rays and thermal stresses age the useful life of roof membrane systems.

Roof membrane systems are either mechanically fastened, ballasted, heat welded or fully adhered with adhesives and solvents. Membranes are both un-reinforced and reinforced with polyesters or fiberglass for strength and dimensional stability and available in a range of thickness from 45 mils to 90 mils. In the roofing industry, thicker roof membranes are considered more durable.

Flexible roof membranes are attached to the roof using one of three methods. Ballasted roof membranes require that the membrane material be laid directly over roof insulation or the roof deck and attached at the perimeter and held in place by gravel ballast or pavers. This system offers a low installation cost. However, the system is restricted by the weight that the roof deck is designed to support. In addition, the ballast material must be removed to locate leaks, making repairs time consuming and costly. In a second method, fully-adhered roof membranes require that the roof membrane be adhered to the roof with contact adhesive. This lightweight system yields high wind resistance and can be used with most deck types. However, fully adhered roof systems depend on the roof insulation to which they are adhered for wind uplift resistance. Roof pads are also often required in high traffic areas to prevent the compression of insulation, delamination of insulation facers, and general damage to the membrane, such as punctures and tears. In a third method, mechanically-attached roof membranes are attached to steel and wood decks with fasteners.

The Environmental Protection Agency's ENERGY STAR® Roof Products Program has established a minimum standard that requires low-slope reflective roof products to have an initial solar reflectance of at least 65 percent, and a reflectance of at least 50 percent after three years of weathering to be considered a ‘Cool Roof’, energy efficient or high performance roof. Cool Roofs typically incorporate bright white membranes that keep moisture out while reflecting ultraviolet and infrared radiation, protecting the underlying insulation and roofing substrate from deterioration. These Cool Roof systems reduce building energy consumption by up to 40 percent, improve insulation performance to reduce winter heat loss and summer heat gain and can potentially reduce HVAC equipment capacity requirements. The Cool Roof reflects light and heat away from the roof deck to assist with maintaining low air conditioning loads and is considered an energy efficiency measure. Reflecting light off the roof membrane results in lower lifetime membrane temperatures and lengthen the life of the roofing system. The success of sustainability initiatives such as the U.S. Green Building Council's LEED rating system, have encouraged the roofing industry to develop cool roof systems that meet or exceed requirements for the U.S. EPA's ENERGY STAR® label for roofing membranes.

The term “photovoltaic” is derived from the root words “photo”, meaning light, and “voltaic”, meaning electricity. Sunlight, the common power source for photovoltaic systems, is composed of photons. The amount of energy in a photon is proportional to the frequency of its light. When photons strike a photovoltaic cell, the photons are either reflected or absorbed. When a photon is absorbed, its energy is transferred to an atom of the cell, where an electron leaves its normal position associated with that atom and moves into a current. A portion of the energy created is electrical, while another portion is thermal in nature.

Photovoltaic cells react to different wavelengths of light as a function of their material composition. Common photovoltaic cell materials include: single crystalline silicon, polycrystalline silicon and amorphous silicon, gallium arsenide, copper indium diselenide, cadmium telluride, dye-sensitive and nano-technologies. In addition, photovoltaic cells, laminates and modules can be composed of two or more layers of different photovoltaic materials with different wavelengths and bandwidth sensitivities to yield improved energy conversion efficiencies.

When exposed to light, photovoltaic cells increase in temperature, which affects each photovoltaic cell materials' energy conversion efficiency in a unique manner. This is measured and known as the Installed Nominal Operating Cell Temperature (INOCT). For example, the efficiency of the crystalline silicon solar cell strongly depends on its operating temperature and the efficiency of the amorphous is less affected by its operating temperature. Accordingly, thin film and flexible amorphous silicon systems have been commercially accepted and flush mounted to membrane roof systems. U.S. Pat. No. 4,860,509 and U.S. Patent Publication No. 2005/0072456 teach examples of flexible, photovoltaic material roofing assemblies, adhered to a single-ply roofing membrane. In the field, however, flexible amorphous silicon cell temperatures have been documented to exceed 77° C. (170° F.). Canadian Patent No. 2,554,494 provides an example of the use of crystalline photovoltaic cells, in a layered fashion that includes a base, flexible membrane layer, a semi-rigid support layer, the photovoltaic layer and a protective layer forming a unitary structure to be adhered directly to the roof. Each of these photovoltaic membrane systems, however, allows the transmission of heat from the photovoltaic cells to the building structure, limiting the operative efficiency and life of the photovoltaic cells and damaging the structural materials of the building and its protective envelope system.

In the field, it is known in the photovoltaic community that for each degree Celsius that a crystalline photovoltaic cell increases over its standard test conditions (STC) rated temperature, its performance goes down by 0.05% of its rated power. Additionally, when photovoltaic cells are integrated into an insulated roof system, there is little opportunity for heat loss off the backside of the modules and this heat is transferred into the building envelope.

Most crystalline silicon based PV arrays exhibit a relative efficiency temperature sensitivity of 0.5%/1° C. It is estimated that thin film amorphous silicon and cadmium arrays, although not as well documented due to their newness in the field, exhibit less than half of the performance temperature sensitivity of crystalline photovoltaic arrays. SANDIA National Laboratory conducted a study that states that, “maintaining an open rack air flow results in 20° C. reduction in average operating temperature, a nearly a 10% greater amount of annual energy (for crystalline silicon), and an untold increase in life expectancy compared to direct mounted arrays on an insulated roof surface.” Unfortunately, photovoltaic specialists have focused on the photovoltaic's INOCT and have not addressed the architectural impact of the increase of cell temperature on the roof system beneath, the heat transfer impact on the buildings thermal performance or the integrity of the building envelope.

Since the late 1980's, building integrated photovoltaic (BIPV) technology and systems have been developed as part of a movement towards whole building design and the efficient, sustainable use of resources. The objective of BIPV technology is to have one system that serves as the protective building envelope and also generates electric power for use within the building in the form of electric roof membranes, electric windows and glazing, electric awnings, electric roof tiles, electric standing seam metal roofing and the like. U.S. Pat. No. 6,553,729 and U.S. Pat. No. 6,729,081 teach examples of photovoltaic modules that are adhered directly to a roof, wall or other portion of the building structure using an adhesive. These photovoltaic systems generate on-site distributed electric power that will offset building electrical loads, decrease building electrical demand, put less demand stress on the local utility transmission system, allow surplus power to be fed back into the utility grid and may provide continuous power supply during utility grid outage.

Photovoltaic membrane roof systems installed on low-sloped roofs may be attached to the roof using mechanical fasteners, ballast or adhesives. As the photovoltaic cell heats up, thermal energy is trapped behind its surface, against the roof membrane, insulation board and deck beneath the photovoltaic cell. Over time, the photovoltaic system effectively stresses and ages the building system underneath establishing a core physical incompatibility of a direct interface between the two systems. Accordingly, prior art systems that directly attach photovoltaic systems to roof decks tend to reduce the performance life of the building materials by elevating temperatures in the building envelope system. Elevated temperatures accelerate and increase the degradation rates of most materials. A common rule of thumb for polymers states that the material life expectancy is reduced by half for each 10° C. rise in average temperature.

Photovoltaic systems mounted directly onto the building envelope trap heat into the roof deck creating a series of hot spots or heat islands on the roof which not only stresses and accelerate the aging of the roof membrane and deck underneath but negatively affecting the building's energy system. The trapped thermal energy can result in greater heat transfer to the building interior and produce a greater demand for air conditioning, which results in a strain on both operating costs and the electric power grid. Such systems further inhibit the ability of the roof insulation to work optimally, in effect requiring that air conditioning loads increase, due to the photovoltaic system. This is inconsistent with the objective of using the photovoltaic system.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A photovoltaic membrane system is provided for use on a building and, optionally, incorporated into the building envelope. It is a low profile, lightweight, photovoltaic integrated membrane system that inhibits the transfer of heat from the photovoltaic cells to the building envelope or interior building materials and space, without trapping the thermal energy behind the photovoltaic cell, laminate or module.

One or more photovoltaic cells, laminates or modules are provided at an upper layer of the system. A thermal barrier is disposed between the one or more photovoltaic cells and a structural member of the building, such as a roof deck. The thermal barrier is positioned to isolate the one or more photovoltaic modules from the building envelope. The thermal barrier may be provided as a series of wedge shapes, incorporated within the membrane system, sloped and spaced in rows, in a manner to optimize the electrical performance of the photovoltaic membrane assembly for the building. An air channel assembly may be disposed between the one or more photovoltaic cells, laminates or modules and the thermal barrier to ventilate heated air from beneath the one or more photovoltaic cells away from the system and the building.

In one aspect, the thermal barrier is formed from a light weight material that substantially inhibits thermal transmission from the one or more photovoltaic modules to the building envelope. A roof membrane layer may be disposed between the one or more photovoltaic modules and the roof deck. A layer of roofing membrane may be disposed between the thermal barrier and the roof deck. Another aspect sandwiches the thermal barrier between layers of roofing membrane. Still another aspect may simply dispose a layer of roofing membrane between the one or more photovoltaic modules and the thermal barrier.

An air channel assembly may be disposed between the one or more photovoltaic modules and the thermal barrier, be part of the photovoltaic module, or be provided as part of the thermal barrier. The air channel assembly may be provided to have at least one air channel that is positioned to direct heated ambient air within the air channel assembly away from the photovoltaic system.

The system may be provided in an assembled form that may be permanently or removably coupled with the envelope of a building. In another aspect, the system may be provided in component parts to be assembled at the building during installation. In one aspect, roofing membrane may be provided with markings to indicate where photovoltaic modules and thermal barriers should be located with respect to the roofing membrane, prior to installing the system on the building.

Also contemplated is an isolation mount that includes an isolator body, which may be a thermal barrier, a first membrane adjacent to a lower surface of the body, and a second membrane extending over the isolator body that includes a peripheral margin that is at least partially sealed or adhered to the first membrane. At least one connector is supported by the isolator body and at least one fastener extends through the second membrane to secure the connector to the isolator body. The connector may include a mounting rail, posts, or an air channel assembly. Alternatively, the fasteners may be captive and attached to the membrane without penetrating the membrane. For example, the fastener may be induction welded to the second membrane.

The isolation mount may include a washer element interposed between the isolator body and the second membrane, where the fasteners extend from the washer element. The isolation mount may also include a third membrane interposed between the isolator body and the washer element.

A photovoltaic module for use on the roof of a building also is provided for in the present application. The photovoltaic module includes at least one isolator body, a first membrane adjacent to a lower surface of the body, and a second membrane extending over the isolator body that includes a peripheral margin that is at least partially sealed to the first membrane. A plurality of connectors are supported by the isolator body and at least one photovoltaic cell is mounted to the connectors. A roof deck panel may be included that supports one or more modules.

A photovoltaic roofing system for use on the roof of a building also is contemplated. The photovoltaic roofing system may include at least one isolator body, and a plurality of isolator bodies. A first membrane is disposed between the isolator bodies and the building. At least one second membrane extends over the isolator bodies and is adhered to the first membrane. A plurality of connectors are supported by the isolator bodies and at least one photovoltaic cell is mounted to the connectors. The system may further include a roof deck that is disposed between the first membrane and the building.

Also contemplated is a method for deploying a photovoltaic roofing system on the roof of a building. The method comprises pre-assembling a first membrane and a second membrane to form a cavity. The second membrane includes a plurality of connectors for supporting a solar panel. The first membrane is secured to the roof and the cavity is filled with foam. The foam is injected into the cavity to form an isolator body. A photovoltaic cell may then be mounted to the connectors.

In another embodiment, an isolation mount comprises a hollow wedge shaped shell having an upper sloped surface and at least three sidewalls extending therefrom to join a surrounding flange. The wedge shaped shell is thermoformed from a rigid plastic material. The upper sloped surface may include stiffening ribs. In an embodiment, the shell may include a ballast recess adapted to contain roofing ballast.

The inner perimeter portion of a skirt membrane is secured to the surrounding flange and an outer perimeter portion of the skirt extends away from the surrounding flange and is attachable to a surface. The inner perimeter portion may be sealed to the surrounding flange. The inner perimeter portion defines a skirt membrane opening leading into the hollow region of the shell such that multiple isolation mounts may be stacked together. In an embodiment, the skirt membrane opening is congruent with the hollow region.

Also contemplated is a photovoltaic module for use on the roof of a building that includes an isolation mount and at least one photovoltaic cell secured to the isolation mount. The isolation mount includes a wedge shaped shell having an upper sloped surface and at least three sidewalls extending therefrom to join a surrounding flange. The isolation mount also includes a skirt membrane having an inner perimeter portion secured to the surrounding flange and an outer perimeter portion extending away from the surrounding flange. In an embodiment, the photovoltaic module includes a plurality of isolation mounts secured to the skirt membrane in an array. The photovoltaic cell is secured to the isolation mount by a plurality of connectors. In an embodiment, a photovoltaic cell may be secured across a plurality of isolation mounts.

A method for deploying a photovoltaic system on a surface comprises pre-assembling a plurality of isolation mounts. Each isolation mount includes a wedge shaped shell having an upper sloped surface and at least three sidewalls extending therefrom to join a surrounding flange. A skirt membrane is secured to the flange and includes a skirt membrane opening into a hollow region of the shell such that multiple isolation mounts may be stacked together. The method further comprises stacking the plurality of isolation mounts together, transporting the isolation mounts to a surface, such as a roof, and unstacking the isolation mounts. The skirts of the isolation mounts are secured to the surface and at least one photovoltaic cell is mounted to at least one of the isolation mounts. The method may further comprise filling a ballast recess formed in the isolation mount with roofing ballast.

The present technology may be applied on buildings as a roof system or as part of a roof system. It may be applied on land, such as a field, as an exposed geomembrane cap or as part of a capture system for landfills, heap leach fields, mining reclamation land, coal ash fields and brownfields. The present technology may be applied on bodies of water including water reservoirs, ponds, canals as a floating cover or floating generator, as a containment system, as a water evaporation inhibitor system, as part of a water treatment or filtration system or a water feature.

These and other aspects of various embodiments of the disclosed technology will be apparent after consideration of the Detailed Description and Figures herein.

### BRIEF DESCRIPTION OF THE DRAWINGS

Non-limiting and non-exhaustive embodiments of the disclosed technology are described with reference to the following figures, wherein like reference numerals refer to like parts throughout the various views unless otherwise specified.

FIG. 1 depicts exemplary embodiments of the photovoltaic membrane assembly as it may be coupled with the envelope of a building;

FIG. 2A depicts a preassembled embodiment of the photovoltaic membrane system;

FIG. 2B depicts modular components of the photovoltaic membrane system before their installation on a building;

FIG. 3A depicts a partially exploded view of the integrated photovoltaic membrane system with an air channel assembly;

FIG. 3B depicts a partially exploded view of the photovoltaic membrane system without an air channel assembly;

FIG. 4A depicts a cut-away, side elevation view of the photovoltaic membrane system depicted in FIG. 3A;

FIG. 4B depicts a cut-away, side elevation view of the photovoltaic membrane system depicted in FIG. 3B;

FIGS. 5A-5D depict various embodiments of air channels that may be incorporated with the photovoltaic membrane system;

FIGS. 6A-6D depict various different embodiments of thermal barriers that may be used with the photovoltaic membrane system;

FIG. 7A depicts one manner in which the thermal barrier of the photovoltaic membrane system can be coupled with a building;

FIG. 7B depicts another manner in which the thermal barrier of the photovoltaic membrane system can be coupled with a building;

FIG. 7C depicts still another manner in which the thermal barrier of the photovoltaic membrane system can be coupled with a building;

FIGS. 8A-8C depict various different embodiments of thermal barriers and thermal barrier units that may be used with the photovoltaic membrane system;

FIG. 9 depicts an exploded perspective view of a photovoltaic roofing system that includes an isolation mount according to an exemplary embodiment;

FIG. 10 is an exploded perspective view depicting an embodiment of an isolation mount;

FIG. 11A depicts a perspective view of an isolation mount according to another exemplary embodiment;

FIG. 11B depicts an exploded perspective view of the isolation mount depicted in FIG. 11A;

FIG. 12 depicts a partial perspective view of an isolation mount for a thin film type solar panel according to an exemplary embodiment;

FIG. 13 is an enlarged partial perspective view of the isolation mount shown in FIG. 12;

FIG. 14 is a partial perspective view of an isolation mount for use with thin film type solar panels according to another exemplary embodiment;

FIG. 15 illustrates an exemplary flat pattern for a second membrane;

FIG. 16 is a side view illustrating a captive fastener configuration for mounting solar panels to an isolation mount;

FIG. 17 is an exploded side view of the captive fastener configuration shown in FIG. 16;

FIG. 18 is an exploded partial perspective view illustrating the installation of washer elements for use with the captive fastener configuration shown in FIGS. 16 and 17;

FIG. 19 is a partial perspective view of the isolator body with washer elements shown in FIG. 18;

FIG. 20 is top plan view of multiple photovoltaic modules pre-assembled to a membrane sheet;

FIG. 21 is side view in elevation of the multi module assembly shown in FIG. 20;

FIG. 22 is a top plan view of an anchor for mounting a membrane sheet to the ground;

FIG. 23 is a side view in elevation of the anchor shown in FIG. 22;

FIG. 24 is a partial perspective view of an isolation mount including a wire management sleeve;

FIG. 25 is a perspective view of a photovoltaic module according to yet another exemplary embodiment;

FIG. 26 is a perspective view of the isolation mount shown in FIG. 25;

FIG. 27 is a front cross-sectional view in elevation of a photovoltaic module according to another exemplary embodiment that is mounted to a surface;

FIG. 28 is a top plan view of the photovoltaic module shown in FIG. 27;

FIG. 29 is an exploded cross-sectional side view of the photovoltaic module shown in FIGS. 27 and 28;

FIG. 30 is a cross-sectional side view in elevation of the photovoltaic module shown in FIGS. 27-29 in an assembled state;

FIG. 31 illustrates an alternative arrangement for securing a photovoltaic module to a surface;

FIG. 32 is a perspective view illustrating another exemplary embodiment of an isolation mount including a ballast recess;

FIG. 33 is a perspective view illustrating another exemplary embodiment of an isolation mount having multiple reinforcing ribs;

FIG. 34 is a top plan view illustrating a photovoltaic module including a single isolation mount;

FIG. 35 is a photovoltaic module illustrating the use of two isolation mounts;

FIG. 36 illustrates a photovoltaic module having multiple differently-sized isolation mounts supporting a plurality of photovoltaic cells;

FIG. 37 is a top plan view illustrating a vertically arranged photovoltaic module array;

FIG. 38 is a top plan view illustrating a horizontally arranged photovoltaic module array;

FIG. 39 is a top plan view illustrating a two-dimensional photovoltaic module array;

FIG. 40 is a cross-sectional side view illustrating an alternative embodiment of the isolation module shell;

FIG. 41 is a cross-sectional side view illustrating yet another embodiment of an isolation mount including an insulation insert;

FIG. 42 is a cross-sectional side view in elevation illustrating an alternative embodiment of a photovoltaic module incorporating standoffs;

FIG. 43 is an alternative exemplary embodiment of a photovoltaic module incorporating standoffs of different lengths; and

FIG. 44 is another exemplary embodiment of an isolation mount using standoffs on top of a shell and including an insert.

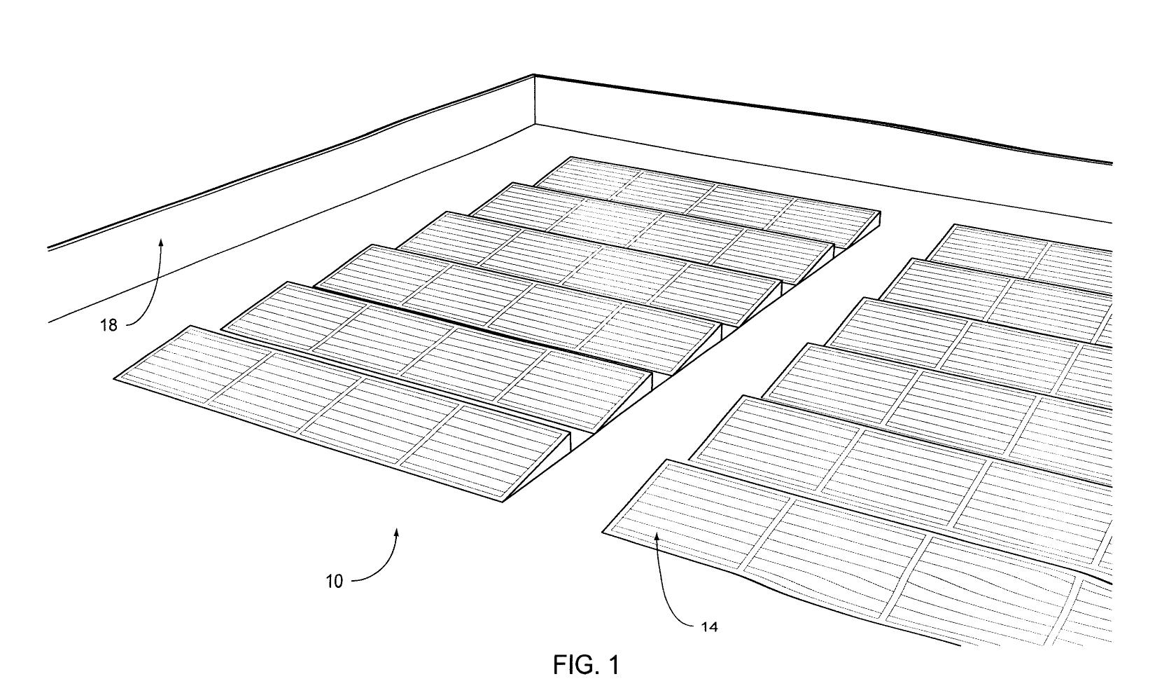

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

In one aspect, the photovoltaic membrane system 10 disposes an isolator body, which may be in the form of a thermal barrier 12, between one or more photovoltaic cells 14 and the roof deck 16 of a building 18 to which the photovoltaic membrane system 10 is coupled. The thermal barrier 12 of the photovoltaic membrane system 10 serves as a physical separation barrier. Specifically, thermal barrier 12 is positioned to significantly limit heat transfer from the photovoltaic cells 14 to the building 18, its interior spaces, and its envelope that may include: a protective roof membrane 20, insulation 22, and roof deck 16. The thermal barrier 12 may also be formed from materials that embody fire resistance properties to provide additional protection to the roof of the building 18.

The thermal barrier 12 may be formed from a variety of materials that include: thermoset polymers; thermoplastics; extruded or molded copolymers; foam; rigid closed cell polyisocyanurate foam core; gypsum glass mat board; fiberglass; fiber board; vapor retardant; slipsheet; flame retardant; cap sheet; or some combination of the aforementioned materials. Each of the aforementioned materials possess similar qualities that individually or in combination retard the transfer of heat and can withstand wide variations in temperature and weather conditions present in most climates.

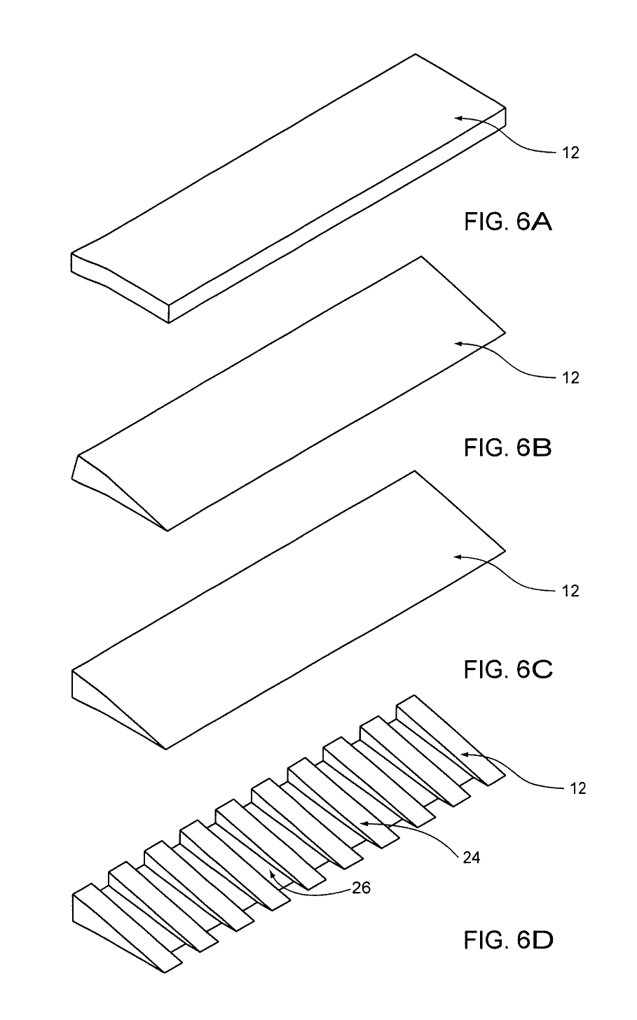

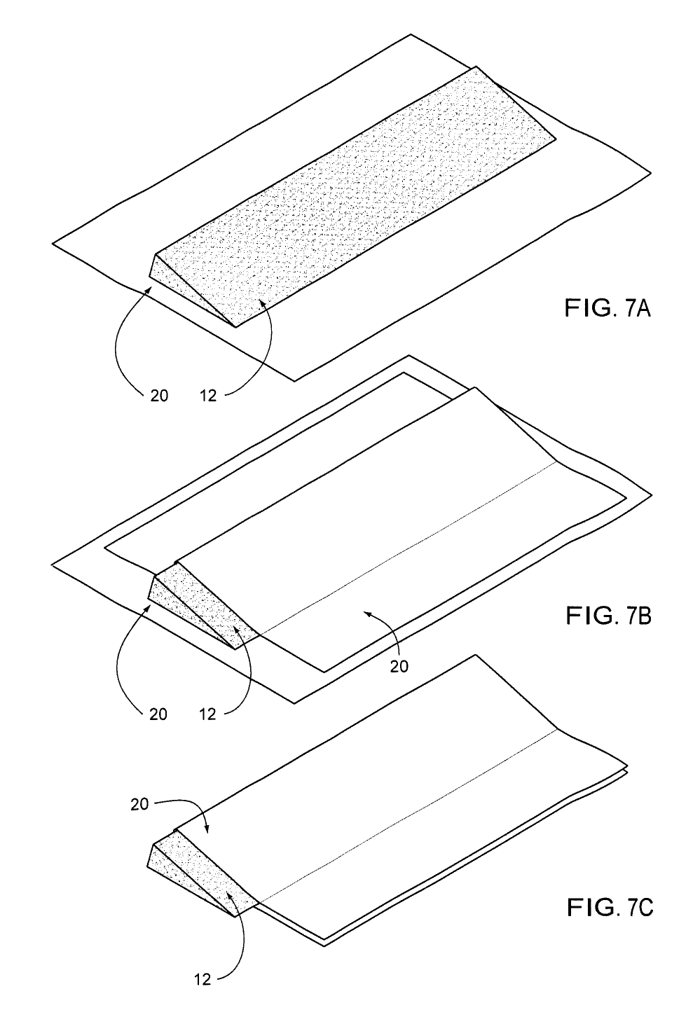

With reference to FIGS. 6A-6D, the thermal barrier 12 may be shaped to resemble a low-profile, flat wedge or low-profile tapered wedge. The exterior perimeter walls of the thermal barrier may be aerodynamically shaped to direct airflow and minimize wind forces on the photovoltaic membrane system 10. One or more peaks 24 and valleys 26 may be formed into the thermal barrier 12 to provide a profile resembling that depicted in FIG. 6D. The peaks 24 of the thermal layer 12 are formed to support the photovoltaic cells 14, angled and sloped to increase the electrical performance of the solar cells, whereas the valleys 26 form channels that permit the flow of fluids, such as air or water between one or more photovoltaic cells 14 and the thermal barrier 12. Accordingly, the spaces formed between the one or more photovoltaic cells 14 and the valleys 26 of the thermal barrier 12 will promote thermal isolation between the photovoltaic cells 14 and the building 18. Such spaces will form insulative barriers utilizing natural convection air flow. The warmed ambient air will escape into the environment or may be directed into conduits that collect the warm air for uses within the building 18. In addition or in the alternative, pipes may be mounted in the valleys 26 such that the valleys 26 may be used as a heat exchanger with water or air pipes.

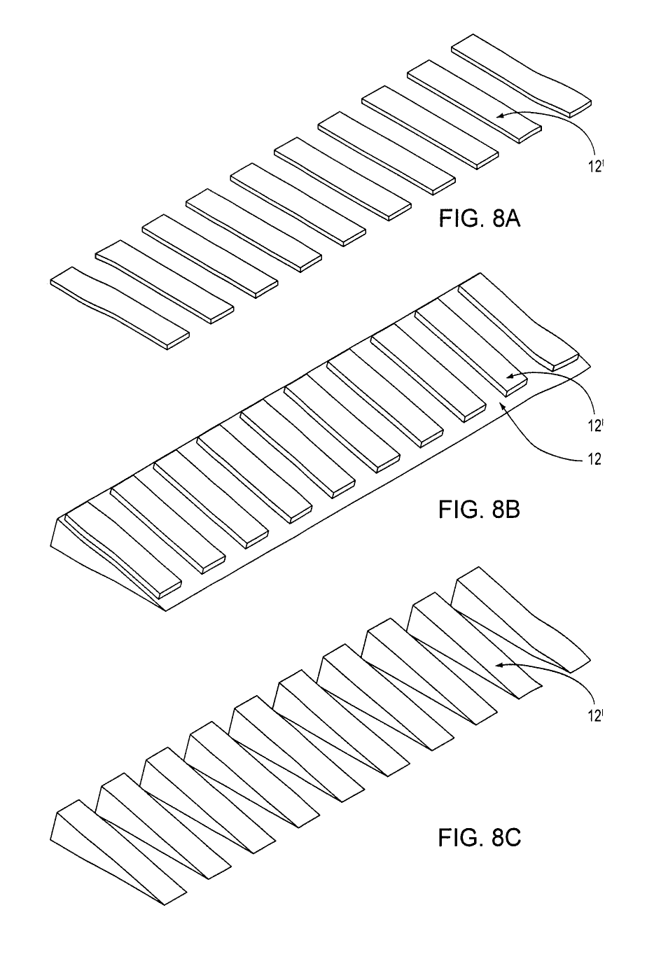

With reference to FIGS. 8A-8C, it is contemplated that the thermal barrier could be provided as a plurality of separate thermal barrier units 12′. In one aspect, the thermal barrier units 12′ may be provided as low-profile blocks, having little or no slope to their shape, such as those depicted in FIG. 8A. In another aspect, the thermal barrier units 12′ may be shaped to take the form of individual tapered wedges, such as those depicted in FIG. 8C. While such thermal barrier units 12′ may be used as the sole thermal barrier 12, they may also be used in combination with the previously described thermal barrier 12, such as depicted in FIG. 8B. In any of the contemplated arrangements that use the thermal barrier units 12′, air channels (such as those previously described are provided between the thermal barrier units 12′ once they are in their final assembly position.

With reference to FIGS. 7A-7C, the thermal barrier 12 may be coupled with the roof of the building 18 in various different manners. For example, FIG. 7A depicts one manner in which he thermal barrier 12 may be coupled with a roof by positioning the thermal barrier 12 directly on a roof membrane surface 20. FIG. 7B, depicting an alternate embodiment, demonstrates that the thermal barrier 12 may be placed between two or more layers of roof membrane material 20. In still another alternate embodiment, FIG. 7C demonstrates that the thermal barrier 12 may be placed under a layer of roofing membrane 20, onto the roof deck 16. In one particular embodiment, it is envisioned that the thermal barrier 12 may be provided as interlocking preformed insulation boards that are coupled with the roof, beneath the roofing membrane 20. Also, optional fire resistant layers may be included. The fire resistant layers may include for example and without limitation materials such as aluminum foil with fiberglass scrim, a synthetic film, or treated gypsum board, such as DensDeck® available from Georgia-Pacific.

The photovoltaic cells 14 of the photovoltaic membrane system 10 are formed into arrays shaped as rows. Specifically, low-profile, flat solar panels may be spaced in rows closely adjacent one other. Alternatively, low-profile, tapered wedge shape panels are laid out in rows at a predetermined space between rows to avoid one row of solar panels from shading the next row to optimize electrical performance.

The thermal barrier 12 may be provided with a reflective layer 28 to enhance the thermal protection afforded by the thermal barrier 12. In one aspect, the reflective layer 28 may be provided in the form of a bright white reflective surface or reflective metal material. By providing such a reflective layer 28, heat radiated from the photovoltaic cell 14 is reflected back toward the photovoltaic cell 14, away from the building 18. Where an air channel assembly 30 is provided, the reflected heat may be passed away from the building 18 and the photovoltaic system through the air channel assembly 30.

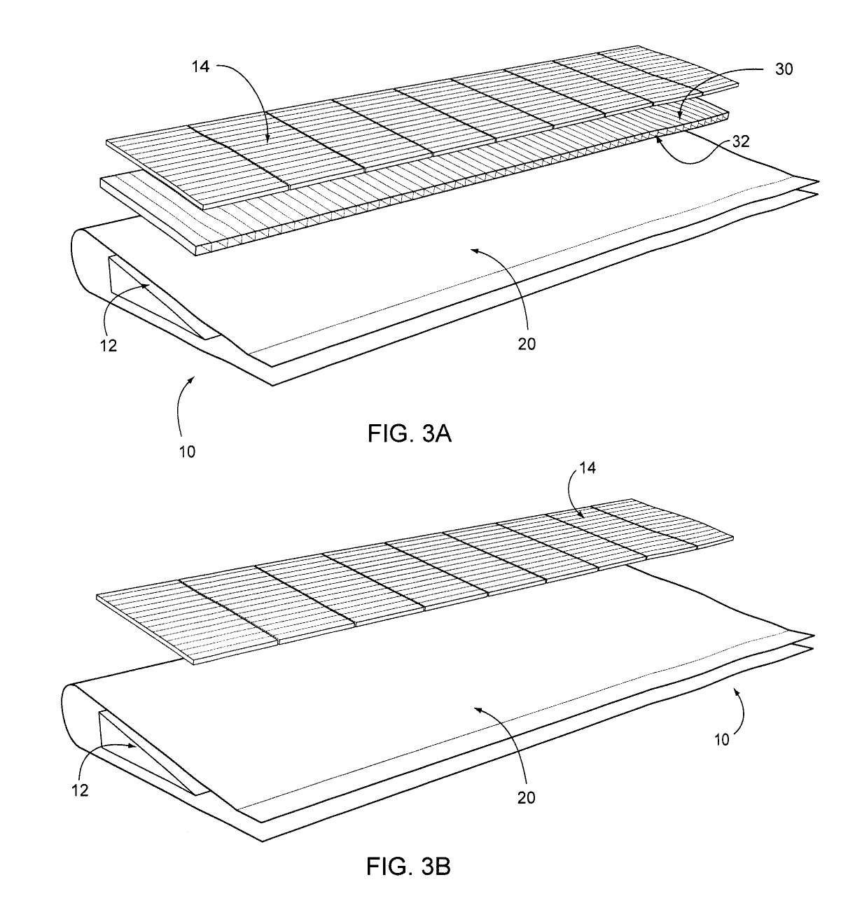

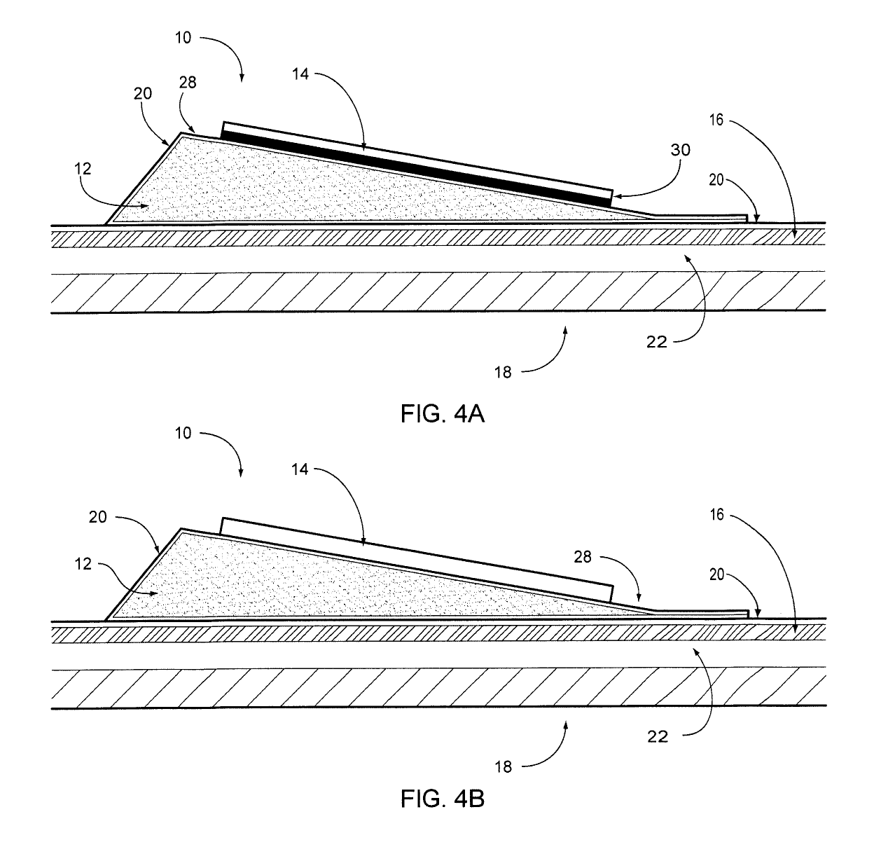

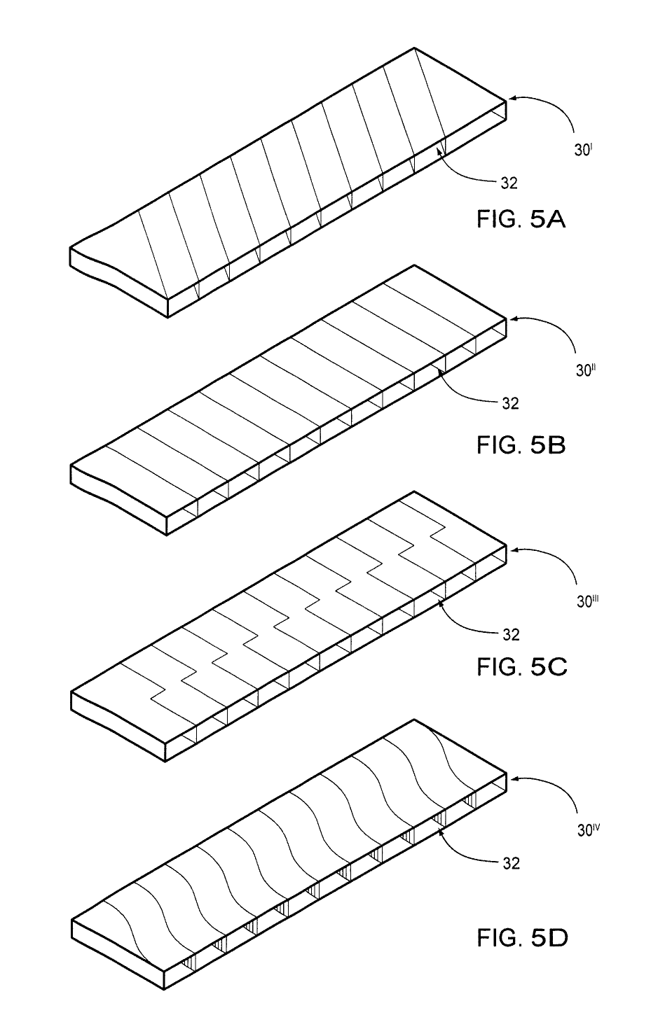

In one aspect, the thermal protection afforded by the thermal barrier 12 may be increased by providing an air channel assembly 30. With reference to FIGS. 3A, 4A and 5A-5D, an air channel assembly 30 may be provided between the photovoltaic cells 14 and the thermal barrier 12. In one embodiment, the air channel assembly 30 is provided to form a physical air space between the photovoltaic cells 14 and the thermal barrier 12. Air within the air channel assembly 30 serves as an insulative layer that inhibits the transfer of heat from the underside of the photovoltaic cells 14 to the thermal barrier 12. However, in another aspect, the air channel assembly 30 is provided with one or more openings 32 that promote the expulsion of heated air away from the photovoltaic membrane system 10 and the building 18.

Generally, the air channel assembly 30 may be formed to provide protective air gaps, cavities or spaces that allow ventilation and circulation behind the photovoltaic cells 14. The specific configuration of the channels within the air channel assembly 30 may vary from one embodiment to another to accommodate particular design considerations. Various design considerations may, for example call to confuse, deflect and reduce wind uplift forces that engage the photovoltaic membrane system 10. Heated air within the air channel assembly 30 will tend to dissipate through the openings 32 naturally by convection. In the end, the combination of the air channel assembly 30 with the thermal barrier 12 will increase the electrical output of the photovoltaic cells 14 by keeping them cooler. Perhaps more importantly, however, these structures will help alleviate the damaging effects of heat being trapped against one or more components to the building envelope, such as roof membrane systems 20.

In one aspect, thermal energy may also be captured from the photovoltaic cells 14 using the air channel assembly 30. Rather than expelling the heated air from the air channel assembly openings 32, the thermal energy within the air channel assembly 30 may be redirected for use within the building energy system. For example, heated air may be directed into the building 18 during winter months. In another aspect, the heated ambient air may be used as a heat exchanger to pre-warm water for use within the building 18.

It is contemplated that the photovoltaic system 10 may be attached to a roof membrane material 20 in the factory or on a jobsite in the field. For example, the rows of photovoltaic cells 14 may be pre-attached to a roof membrane material 20 in a strip format. Providing photovoltaic membrane strips of this nature will limit installation decisions at job sites by roofers and speed the installation of the system. However, in various situations, preassembly may not be preferred, including custom roofing applications. In such instances, roofing membrane material 20 may be pre-marked with indelible ink, paint, and adhesive or scored to provide direction as to where to attach the photovoltaic cells 14.

In attaching the photovoltaic membrane system 10 with a roof, a variety of attachment methods may be employed that are currently used for installing traditional roof membrane systems. For example, the system may be coupled with the roof using mechanical fasteners. Other techniques, such as heat-welding methods, glues, pressure-sensitive or peel-and-stick adhesives may be used. In still other embodiments, the photovoltaic membrane system 10 may be ballasted to the top surface of the roofing membrane 20, insulation board 22 or fastened directly to the roof deck 16.

It is contemplated that the photovoltaic membrane system 10 may be provided as a permanent installation or made a part of a temporary, removable photovoltaic system. Specifically, the photovoltaic membrane system 10 may be fully integrated as the roof membrane layer 20 or with one or more roof membrane layers 20 of the building envelope. Where provided in a removable fashion, the photovoltaic membrane system 10 may be ideal for use as a portable power supply or removable personal property equipment for power purchase agreements. Various possibilities for temporary attachment include the use of ballasting techniques or anchoring the system in place between the rows and along perimeter PVC pipes or other polymer extrusion. The system may also be anchored over the rows. It is further contemplated that other fastening methods may be used, including the use of grommets attached with cables or guy wires to perimeter parapet walls or to anchors in roof.

It is further contemplated that the photovoltaic membrane system could be used in various applications beyond buildings. For example, the system could be deployed on the ground, such as on a landfill, mining site, or waste disposal cell. The system could be adhered to the geomembrane of a landfill. Geomembranes are made of various materials. Some common geomembrane materials are EPDM rubber (ethylene propylene diene Monomer, Low-Density Polyethylene (LDPE), High-Density Polyethylene (HDPE), Polyvinyl Chloride (PVC), Polyurea and Polypropylene (PP). Another type of geomembrane is bituminous geomembrane (such as Environap), which is actually a layered product of glass and bitumen-impregnated non-woven geotextile. The geomembrane may be water tight or water permeable.

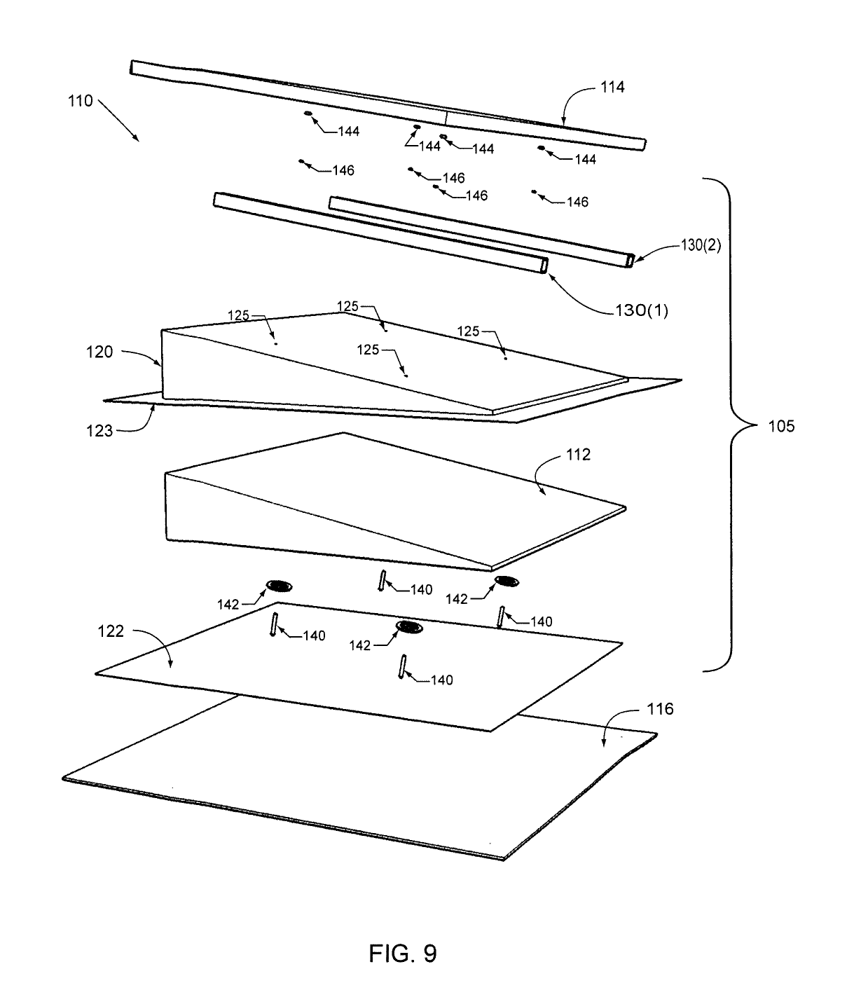

FIG. 9 depicts an isolation mount 105, which may be used to support a photovoltaic cell 114 on a roof surface 116. The isolation mount 105 and the photovoltaic cell 114 may be combined to form a photovoltaic module for use on the roof of a building. Isolation mount 105 includes an isolator body 112, a first, or lower, membrane 122 that is adjacent to the lower surface of isolator body 112, and a second, or top, membrane 120 that extends over the isolator body 112. Second membrane 120 includes a peripheral margin 123 that is at least partially sealed to first membrane 122. The membranes may be sealed or adhered to each other by hot air weld, dielectric high radio frequency welding, water resistant solvent-based adhesive, and the like. Ideally, the peripheral margin 123 forms a hermetic seal or a waterproof seal between first membrane 122 and second membrane 120. The membranes may be comprised of water resistant materials such as thermoplastics (TP), thermosets (TS), thermoplastics olefins (TPO), polyvinyl chloride (PVC), chlorinated polyethylene (CPE), chlorosulfanated polyethylene (CPSE), keytone ethylene ester (KEE), ethylene propylene diene rubber (EPDM), tri-polymer alloy (TPA), combinations thereof, and the like. The membranes, particularly the upper membrane that extends over the isolator body, may be formed by, for example, heating the membrane material and vacuum forming over the isolator body or similarly shaped mold (i.e. thermoforming). The membrane may be a preformed shell formed by injection molding or thermoforming, for example.

Alternatively, the upper membrane may be formed by folding a flat pattern 600, as illustrated in FIG. 15, and hot air welding the flaps in the folded configuration. Pattern 600 includes a central portion 602, a back portion 604, and right and left side portions 606 and 608 respectively. In order to form the top membrane the side portions 606, 608 are folded down along lines 601 and 603 respectively. Back portion 604 is folded down along line 605. Flaps 610 and 612 are then folded along lines 607 and 609 respectively at which point flaps 610 and 612 may be attached to side portions 606 and 608. As explained above, the flaps may be heat, induction, or radio frequency (RF) welded or otherwise adhered to the side portions. It can be appreciated that once folded the flat pattern forms a wedge shaped top membrane as described herein with respect to the various embodiments. Peripheral portions 623′-623′ comprise a peripheral margin that may be used to attach the top membrane to the roof membrane or the bottom membrane of the isolation mount.

Photovoltaic cell 114 may be adhered to the top membrane 120 with adhesive, such as adhesive tape or painted adhesive. Photovoltaic cell 114 may also be attached to the top membrane 120 with cooperative hook and loop material such as Velcro®. In this instance, however, isolation mount 105 includes a pair of connectors in the form of mounting rails 130(1) and 130(2), which are supported by isolator body 112. Mounting rails 130 may in turn support a photovoltaic cell 114. Mounting rails 130 may comprise, for example, metal or plastic and may be molded, machined, or extruded. Various connectors may be employed, such as rails, posts, air channel assemblies (see above), cooperative hook and loop material, and the like. The mounting rails are also adapted to secure the photovoltaic cell 114 to the isolation mount 105. In this embodiment, a plurality of fasteners 140 extend through isolator body 112 and second membrane 120 in order to secure mounting rails 130 to the isolation mount. Washers 142 may be used to distribute clamping forces generated by fasteners 140 across a larger area of the lower surface of isolator body 112. Fasteners 140 may extend through holes 125 formed in the second membrane 120 or the fasteners may pierce through membrane 120. Fasteners 140, holes 125, and washers 142 may be applied with caulk or the like to seal the leak path formed by the device. Similarly, isolator body 112 may be preformed with holes, or as shown here, the fasteners may pierce through the isolator body 112. In this case, where the isolator body 112 is a thermal barrier, the body may be formed of a foam material conducive to piercing with a suitable fastener. Fasteners 140 may engage the mounting rails 130 directly, as with threads, or the fasteners 140 may cooperate with mating fasteners or nuts 144.

Depending on the application, isolator body 112 may be formed from various materials. For example, as shown in FIG. 9 isolator body 112 is comprised of a thermal barrier material for use with photovoltaic cells as described above. While some of the embodiments are described with respect to photovoltaic cells, the isolation mount may be used to mount other equipment. For example, isolator body 112 may be formed of a vibration dampening material for mounting reciprocating equipment. Examples of suitable materials for the isolator body include, for example and without limitation, faced or unfaced insulation board, expanded polystyrene (EPS), polyisocyanurate foam, fiber glass insulating board, plywood, oriented strand board (OSB), gypsum board, DensDeck®, wood fiber, fiberglass board, coverboard, plastic, plastic blend materials, and the like. The isolator body may also be formed of a two part liquid or expanding spray foam that is injected between the first and second membranes. Example spray foams that may be used include polyisocyanurate spray foam, closed-cell polyurethane spray foam, open-cell polyurethane spray foam, phenolic spray foam, icynene spray foam or other spray foam.

It should be appreciated that a photovoltaic roofing system 110 is also contemplated, which employs an isolation mount, such as isolation mount 105 described above. With continued reference to FIG. 9, roofing system 110 could include a plurality of isolator bodies 112, wherein the lower membrane 122 extends beneath the isolator bodies and functions as a roof membrane. A plurality of second membranes 120 may be disposed over each of the isolator bodies. Alternatively, a single upper membrane 120 could extend over the plurality of bodies. It is further contemplated that such a multiple isolator body construction could be preformed and folded or rolled for convenient deployment on a roof surface 116. Alternatively, the first and second membranes could be adhered to each other without the isolator body. In such a case the membranes could be deployed on the roof and thereafter injected (i.e. inflated) with foam or two part liquid as explained above. The roofing system may also include roof deck panels. The panels may be formed from materials including metal, fibrous cement, gypsum, cementitious wood fiber, OSB, lightweight insulating concrete decks, and the like.

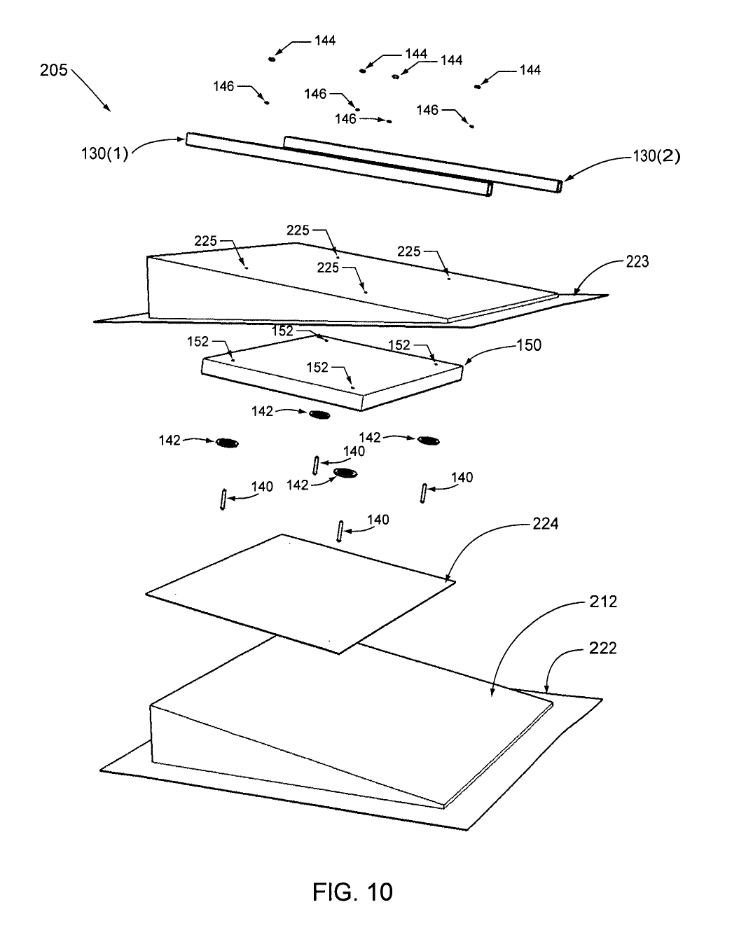

FIG. 10 depicts another embodiment of an isolation mount 205, which is similar to the embodiment described above with respect to FIG. 9. However, in this embodiment isolation mount 205 includes washer element 150 interposed between isolator body 212 and second membrane 220. Optionally, a third membrane 224 may be interposed between isolator body 212 and washer element 150. In this embodiment, fasteners 140 extend from washer element 150 and through second membrane 220 and through mounting rails 130. As shown in this case, fasteners 140 engage mating fasteners (nuts) 144 thereby developing clamping force to secure mounting rails 132 to isolation mount 205. As an option, additional washers 142 and 146 may be used as shown. In this case washer element 150 distributes the clamping force over a relatively large area of second membrane 220 providing resistance to wind uplift and damage to the mount. Washer element 150 may be comprised of faced or unfaced insulation board, expanded polystyrene, polyisocyanurate foam, fiber glass insulating board, plywood, oriented strand board, gypsum board, DensDeck®, wood fiber, fiberglass board, coverboard, thermoformed, compressed or injection molded plastic and plastic blend materials, to name a few. It should be appreciated that the construction of this embodiment may be incorporated into a photovoltaic module and/or photovoltaic roof system as explained above with respect to FIG. 9.

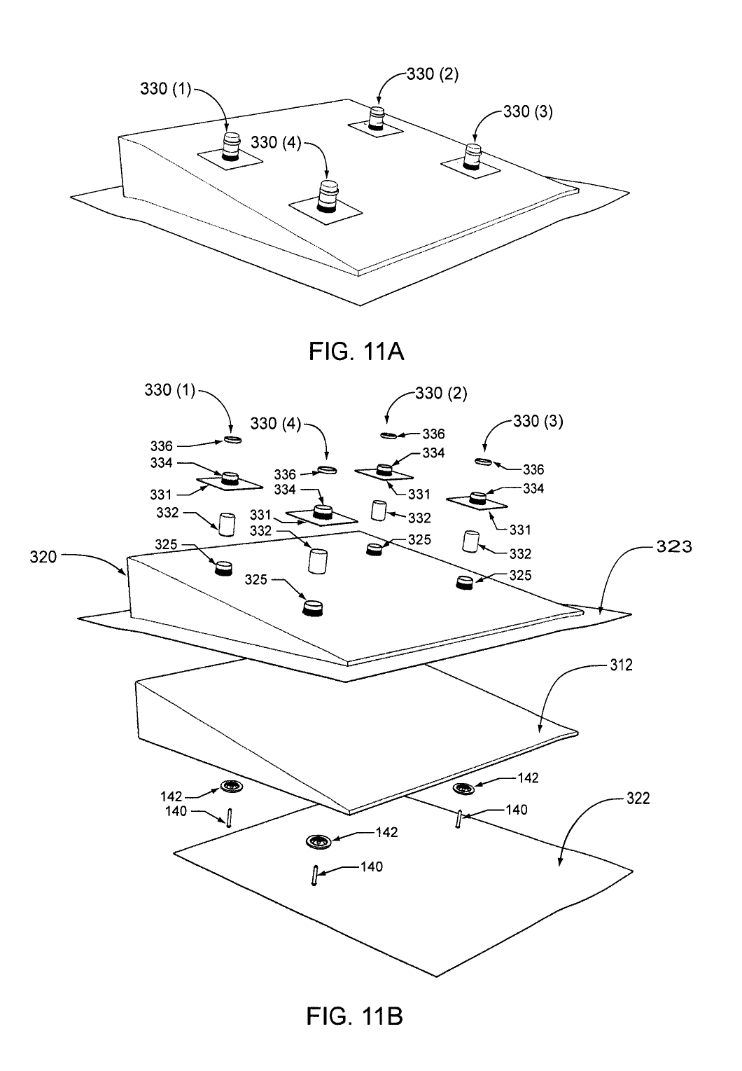

FIGS. 11A and 11B depict yet another embodiment of an isolation mount 305. Isolation mount 305 is similar to that as described above with respect to FIG. 9. In this case, however, each connector 330(1)-330(4) includes a mounting post 332. Mounting posts 332 may be comprised of for example, extruded plastic or pipe. Each mounting post 332 extends through an opening 325 formed through second membrane 320. Opening 325 may be formed by extruding a cylindrical portion upwardly from membrane 320. For example, openings 325 may be formed by a die-punch operation including heating the membrane prior to punching. Fasteners 140 extend through washers 142, isolator body 312, and engage posts 332. Posts 332 are further secured to the isolation mount with connector seals 334, which include a flange portion 331. Connector seals 334 may be formed in a similar manner to that as described above for openings 325. The flange portions 331 of connector seals 324 are sealed to second membrane 320. Connector seals 334 are also sealed to posts 332 with a suitable water resistant caulk, such as for example, polyurethane caulk, non-shrink grout, sealing mastic, silicone, glue, and the like. Optionally, a tension or draw band 336 may be secured around the connector seal and post in order to further inhibit ingress of water or other fluid into the isolation mount. As above, it should be appreciated that the construction of this embodiment may be incorporated into a photovoltaic module and/or photovoltaic roof system as explained above with respect to FIG. 9.

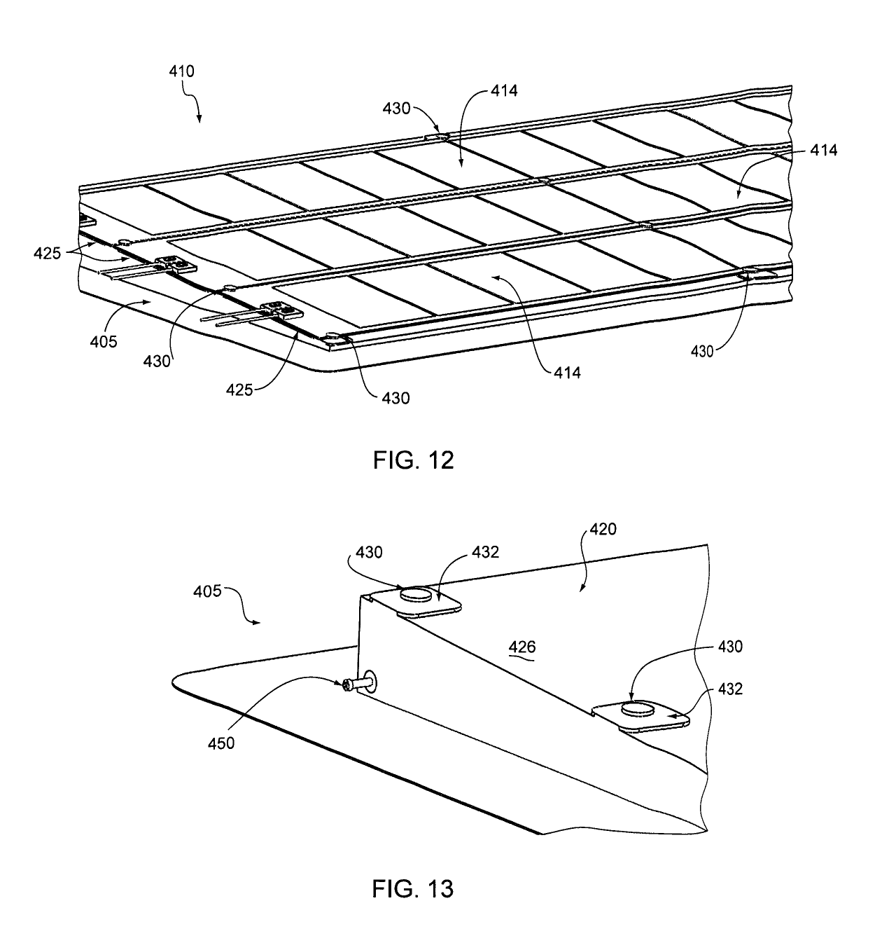

FIG. 12 illustrates an exemplary embodiment of an isolation mount 405 for use in a system 410 using thin film or laminate type solar panels 414. Laminate type solar panels from manufacturers such as UniSolar® often include adhesive 425 for adhering the panel directly to the membrane material. However, there is concern that as the solar panel heats up, as described above, the adhesive bond may slip or weaken. Accordingly, in order to help ensure the attachment of the solar panel 414 to the top membrane 420, connectors in the form of fastener clips 430 are integrated into the isolation mount 405. With further reference to FIG. 13 it can be appreciated that the clips 430 are positioned on a corresponding boss 432 that is elevated above the top membrane 420. The boss 432 is raised sufficiently to provide clearance 426 for typical adhesive material 425 used to adhere the solar panel 414 to the membrane 420. Each clip 430 is spaced slightly above its corresponding boss 432 to provide clearance for an edge of the solar panel 414 to slide between the top of the clip 430 and boss 432 as shown in FIG. 12. One ordinarily skilled in the art will recognize that clip 430 and boss 432 could comprise separate pieces or be integrally formed, such as by injection molding.

The isolation mount 405 also includes a fitting 450 which allows any water or air that may accumulate within the isolation mount 405 to drain therefrom. Fitting 450 extends through the side of the top membrane into the interior of the mount. The fitting 450 may include a screen or other filtering element (see FIG. 13), such as sintered metal or plastic, to prevent the ingress of dirt and insects, for example. Fitting 450 could also be a check valve to allow air and water out but prevent air, water, and debris from entering the isolator. It is contemplated that a similar fitting 450 could be implemented on any of the embodiments described herein as desired. Moreover, fitting 450 could be used as an inlet to inflate the isolation mount with spray foam as explained above.

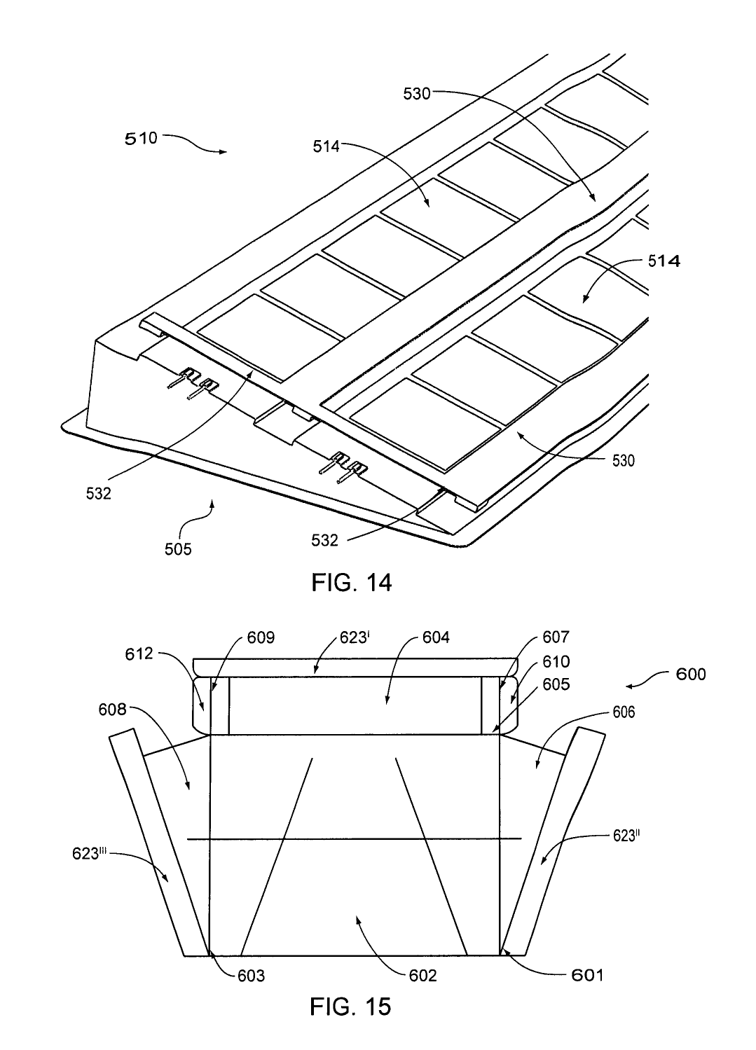

FIG. 14 illustrates another exemplary embodiment of an isolation mount 505 for use with thin film, laminate type, or otherwise non-glass solar panels 514. In this embodiment the laminate panels 514 are secured to the membrane by straps 530. Straps 530 extend along the length of solar panels 514 and include fingers 532 on each end that extend along a portion of the solar panel's width. Straps 530 and fingers 532 are welded or otherwise fastened to the adjacent membrane to form a pocket in order to help secure solar panels 514 in position.

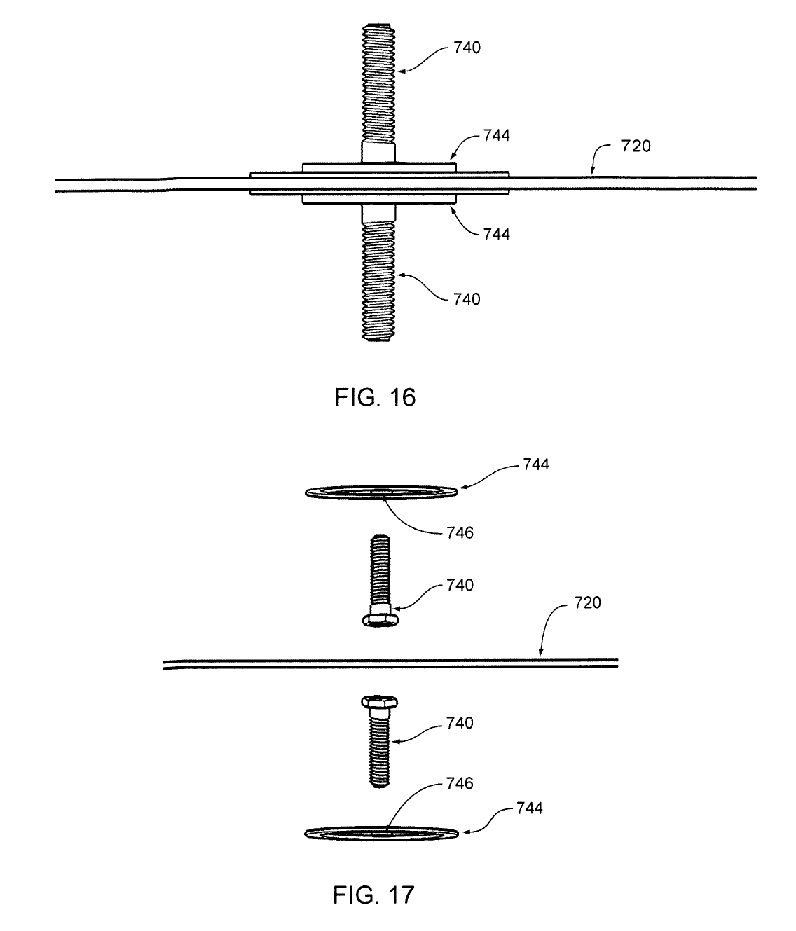

FIGS. 16 and 17 illustrate the attachment of fasteners 740 to membrane 720 according to another exemplary embodiment. In this embodiment, fasteners 740 are captive with respect to washers 744. Fasteners 740 are carriage bolts having a square shank which engages a square hole 746 formed through washer 744, thereby preventing rotation of the fasteners relative to washers 744. Washers 744 are induction welded to membrane 720 without penetrating the membrane. Each washer is bonded to the membrane with an induction welder. The washers include a heat activated adhesive. A suitable induction welder is approved by Firestone, Cralisle Syntec, Johns Manville, Sika® Sarnafil®, Durolast, Seaman Fibertite, and marketed as the Rhinobond System.

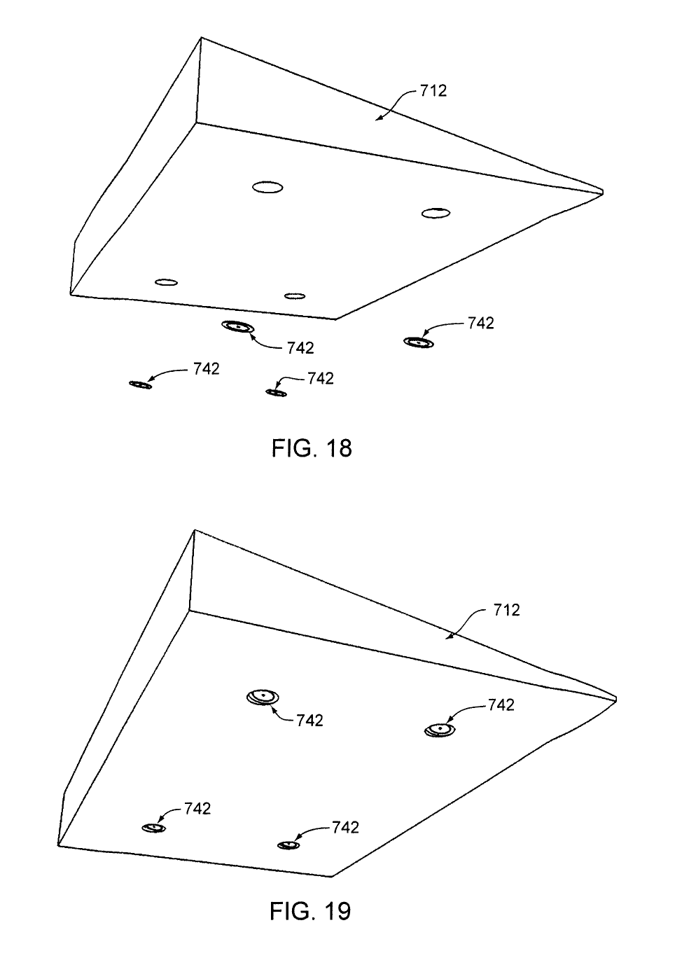

The Rhinobond System is typically used to install only one washer to the underside of a membrane. However, as shown in the figures, two fasteners 740 and washers 744 are bonded to membrane 720; one on the top side one on the underside. With further reference to FIGS. 18 and 19, the fastener on the top side of the membrane may be used to attach solar panel mounting connectors, while the fastener on the under side of the membrane is used to anchor the solar panel and membrane to the isolator body. The fastener 740 extending from the underside of the membrane 720 is configured to extend through the isolator body where an additional washer 742 may be used to distribute clamping forces generated by fasteners 740 across a larger area of the lower surface of isolator body 712. The Rhinobond System may be modified to help facilitate welding two fasteners simultaneously by forming a hole in the Rhinobond machine through the middle of induction coil. The hold would allow the fastener to extend therethrough moving the induction coil closer to the washers. The two fasteners may also be installed in an offset arrangement such that the washer and fastener on the top of the membrane is offset from the washer and fastener on the bottom. In an offset arrangement the washers can be welded to the membrane one at a time.

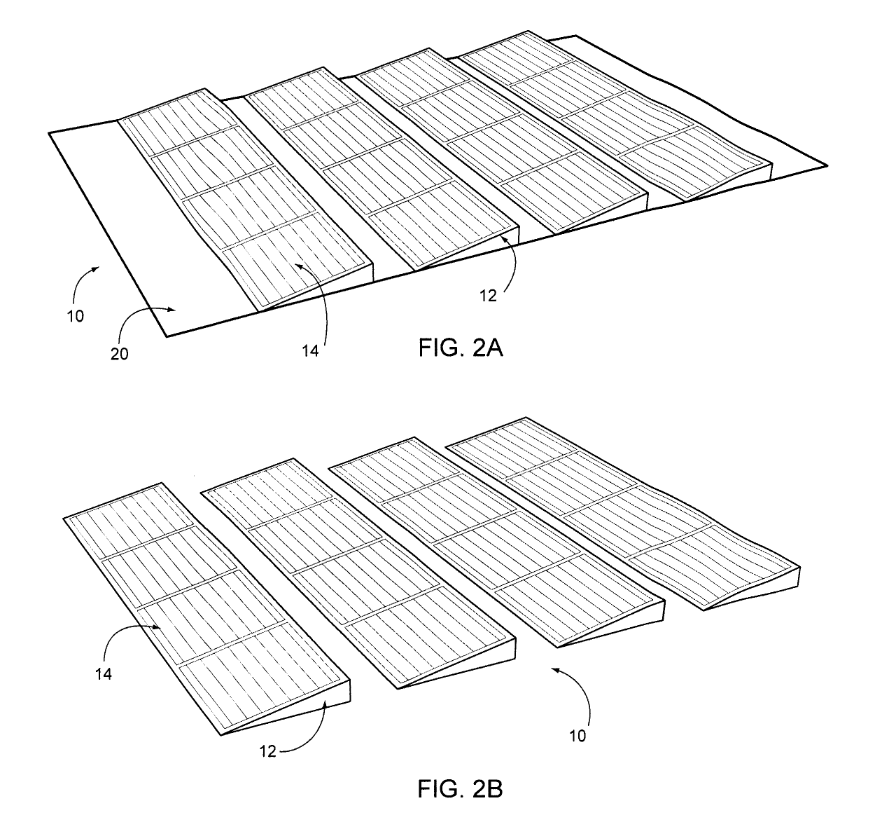

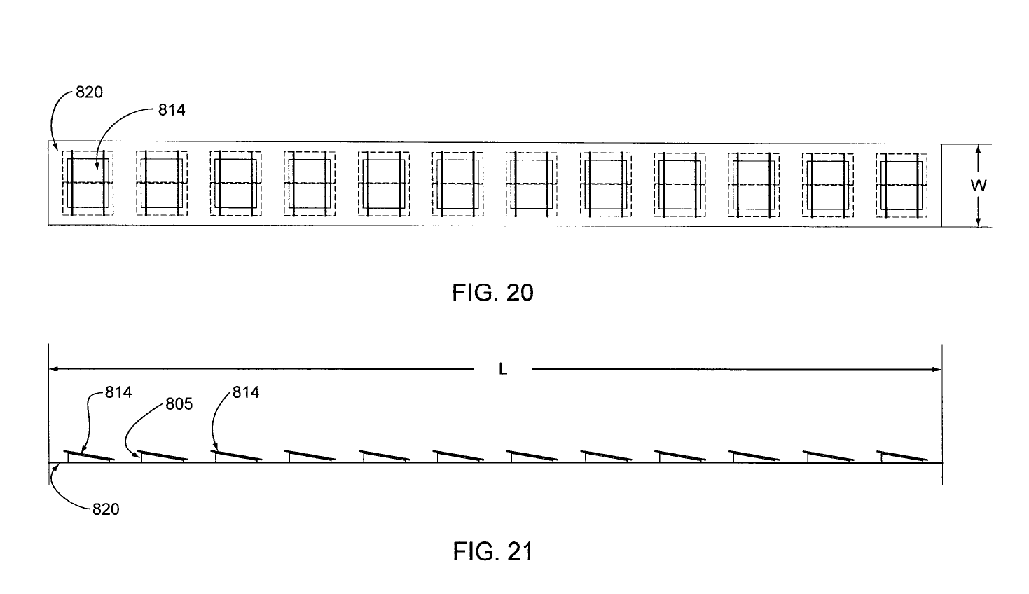

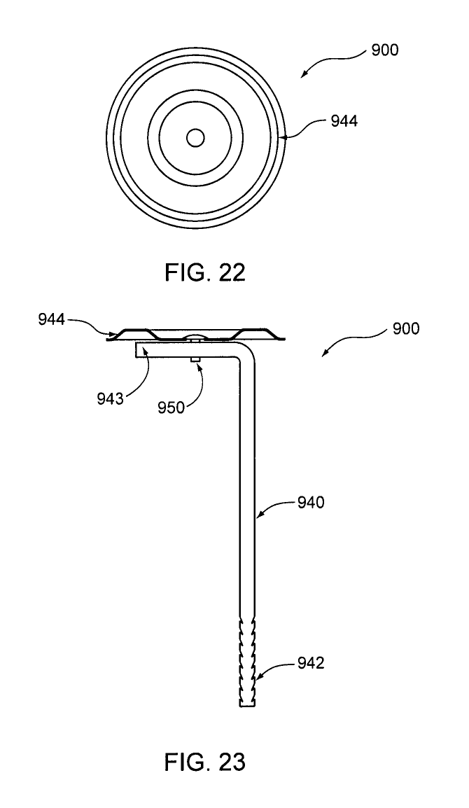

FIGS. 20 and 21 illustrate an alternative configuration for preassembling multiple photovoltaic modules to a membrane sheet 820, similar to that shown above in FIG. 2A. The modules may be folded and stacked onto or next to each other in an accordion fashion. The sheet can be quickly pulled apart on the jobsite for a cost effective installation. In this configuration, the modules are preassembled on a standard roll of membrane material having a length (L) and a width (W). For example the roll may be 100 feet long and 8 feet wide. Modules may be preassembled to geomembrane material and be installed as one unit to reduce onsite labor. FIGS. 20 and 21 illustrate attaching 48 solar panels 814 (4 on each isolation mount 805) on isolator bodies to create one large membrane that will cover an area approximately 100 feet×8 feet. This can be used as the watertight layer of the roof, as the single ply membrane layer in a roof assembly to integrate multiple photovoltaic units at one time, or as a solar geomembrane cap to cover a landfill to inhibit water migration from the landfill into the groundwater, streams, rivers etc. The membrane material may be anchored to the ground using an anchor 900 as shown in FIGS. 22 and 23. Anchor 900 includes a washer 944 and a stake 940. The washer 944 is attached to the stake 940 with a suitable fastener 950 as shown. The fastener engages a bent over portion 943 of stake 940. Stake 940 also includes at least one barb 942, or as shown here a plurality of barbs, operative to help retain the stake 940 in the ground.

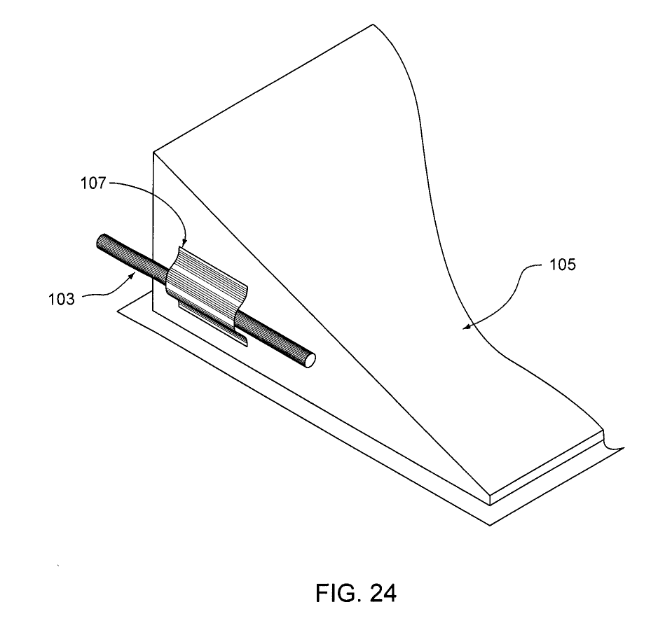

FIG. 24 illustrates an isolation mount 105 that includes a wire management sleeve 107 attached thereto. The wire management sleeve 107 could be adhered or heat welded to any one of the isolation mount embodiments disclosed herein. The wire management sleeve 107 is sized and configured to accommodate wire or conduit 103 associated with the photovoltaic cells.

FIG. 25 illustrates a photovoltaic module 1000 according to another exemplary embodiment. In this case, photovoltaic module 1000 comprises an isolation mount 1010 which supports a photovoltaic cell 1002. Photovoltaic cell 1002 is attached to isolation mount 1010 with a plurality of clips 1004. With continued reference to FIG. 26, isolation mount 1010 comprises a shell 1020 which is sealed or secured to a surrounding skirt membrane 1040. In this embodiment, shell 1020 is a hollow wedge-shaped shell having an upper sloped surface 1032 with a plurality of side walls extending therefrom to join a surrounding flange 1034. In this case, there are three surrounding side walls 1035, 1036, and 1038. However, the shell may include additional or fewer side walls depending on the shape. In an embodiment, the shell could include a fourth wall opposite wall 1036. Additionally, the walls may have one or more openings 1035v (not shown), 1036v, and 1038v to allow airflow in and out of the shell 1020.

In this embodiment, front side wall 1036 includes a cricket 1030. A cricket is also sometimes referred to as a saddle which prevents standing water from building up, ponding, on the upslope side of a roof attachment. In this embodiment, the upper surface 1032 includes a plurality of ribs to add strength and rigidity to the shell. A central rib 1022 extends along the slope of surface 1032 approximately in the middle of the surface. On either side, of central rib 1022 there are ribs 1024 which include attachment bosses 1026. Each attachment boss 1026 has an aperture or a threaded opening 1028 formed therein. The threaded openings may receive fasteners used to attach clips 1004.

The wedge-shaped shell 1020 is preferably formed from a thermoforming process which creates a hollow shell. The shell 1020 may be formed of any suitable material such as a rigid plastic material. For example, polymer materials in the polyvinyl chloride or polyolefin family are suitable for thermoforming the shells. Other materials may provide flame or fire resistance such as Noryl or modified Acrylonitrile Butadiene Styrene (ABS) for heat resistance, impact resistance, and high heat distortion resistance. A reflective polymer layer can enhance solar reflectance index (SRI) with an optical film, reflectance film, or single ply roof membrane. Multiple layers may be thermoformed together to provide the desired combination of strength, fire resistance, and reflectivity, for example. Other materials may include individual resins or combinations of: Noryl, ABS, Acrylic, Styrene, Polyethelene (PE), Polycarbonate Polypropylene (PP), Thermoplastic Urethane (TPU) Nylon, Glass, Ceramics, Fiber Reinforced Plastic (FBR), Biodegradable Bioplastic (PLA polylactic acid). Fillers may be used to reduce materials cost, such as recycled materials, regrind resin from production runs, and caulk. Fillers may be used to increase material strength, such as glass shards and glass fibers.

The shells may also be injection molded in one or more parts with similar polymers. Other production techniques may be employed as well. For example, Direct Digital Manufacturing (DDM) with 3-D printing. Methods of 3-D printing include: Stereolithography Apparatus (SLA), Fused Deposition Modeling (FDM), Selective Laser Sintering (SLS), Selective Laser Melting (SLM) and Multi-Jet Modeling (MJM).

The skirt membrane 1040 may be comprised of any roof surface compatible material such as PVC or TPO. The thickness of the skirt membrane will typically match the thickness of the existing roof surface which may be, for example, 36 mil, 45 mil, 60 mil, or 80 mil membranes. For EPDM roof membranes a TPO skirt or sheet is a compatible material. For Built Up Roof (BUR) surfaces a TPO or PVC felt-back or fleece-back membrane is compatible material. The surrounding skirt membrane 1040 has an outer perimeter portion 1042 extending away from the flange 1034 and is used to secure the isolation mount to a surface. The skirt membrane performs as an intermediary layer to attach the isolation mount to a roof assembly and gain the mechanical properties to resist seismic and wind uplift forces with roof fasteners or adhesives and without penetrating through the roof.

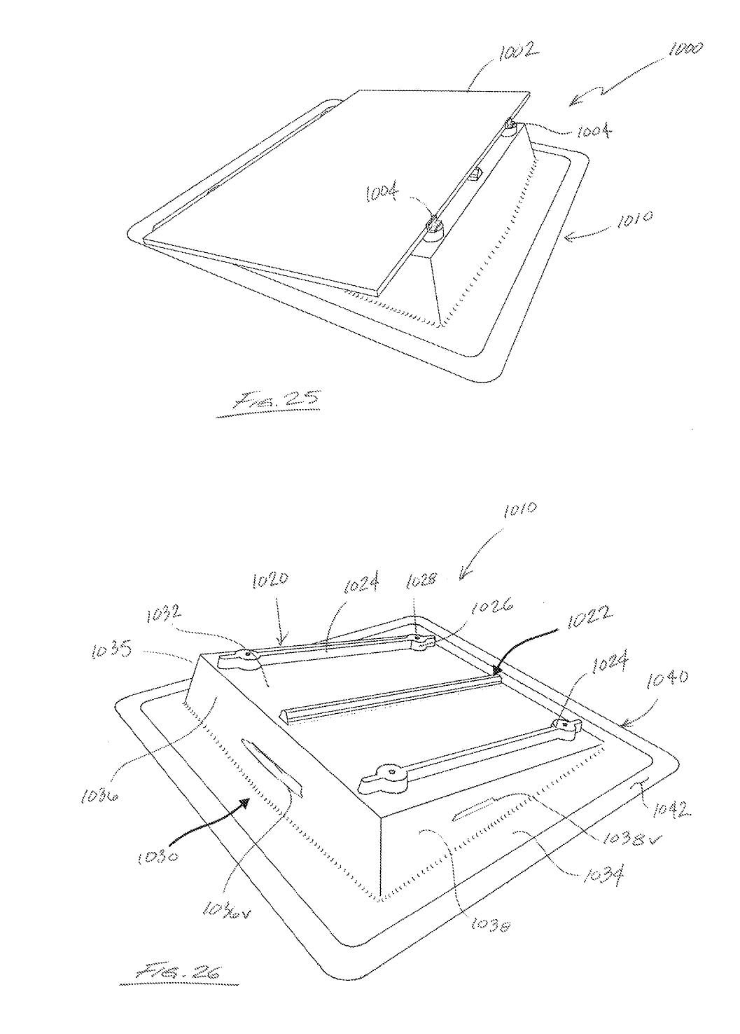

FIGS. 27 and 28 illustrate another embodiment of a photovoltaic module 1100 which incorporates a hollow shell 1120. Isolation mount 1110 includes a shell 1120 and surrounding membrane 1140. In this case, hollow shell 1120 includes a pair of outer ribs 1124 and a pair of central ribs 1122. Furthermore, shell 1120 includes a front rib 1123. These ribs provide reinforcement and structural rigidity to the thermoformed shell which may otherwise be flexible over larger surfaces. The photovoltaic cell 1002 is secured to the ribs 1124, 1122 with a plurality of clips or clamps 1004. The surrounding skirt membrane 1140 is attached to flange 1134 around an inner perimeter portion 1144. The inner perimeter portion 1144 defines a skirt membrane opening 1143 that is congruent with hollow region 1145 of shell 1120. Accordingly, multiple isolation mounts may be stacked together. To facilitate stacking the sidewalls 1035, 1036, and 1038 may be slightly convergent. The inner perimeter portion 1144 may be secured to flange 1134 by hot air welding the flexible membrane sheet or skirt to the flange. Alternatively, the flange may also be adhered to the skirt membrane with liquid adhesive, adhesive seam tape, or induction welding.

An outer perimeter portion 1142 extends away from flange 1134 and may be attached to a surface, such as roof membrane 1003. Roof membrane 1003, as is known in the art, is part of a roofing system which may incorporate a membrane 1003 attached to an insulation board 1005 which, in turn, is attached to roof deck 1007. With reference to FIG. 28, in particular, it can be appreciated that isolation mount 1110 also includes a cricket 1130.

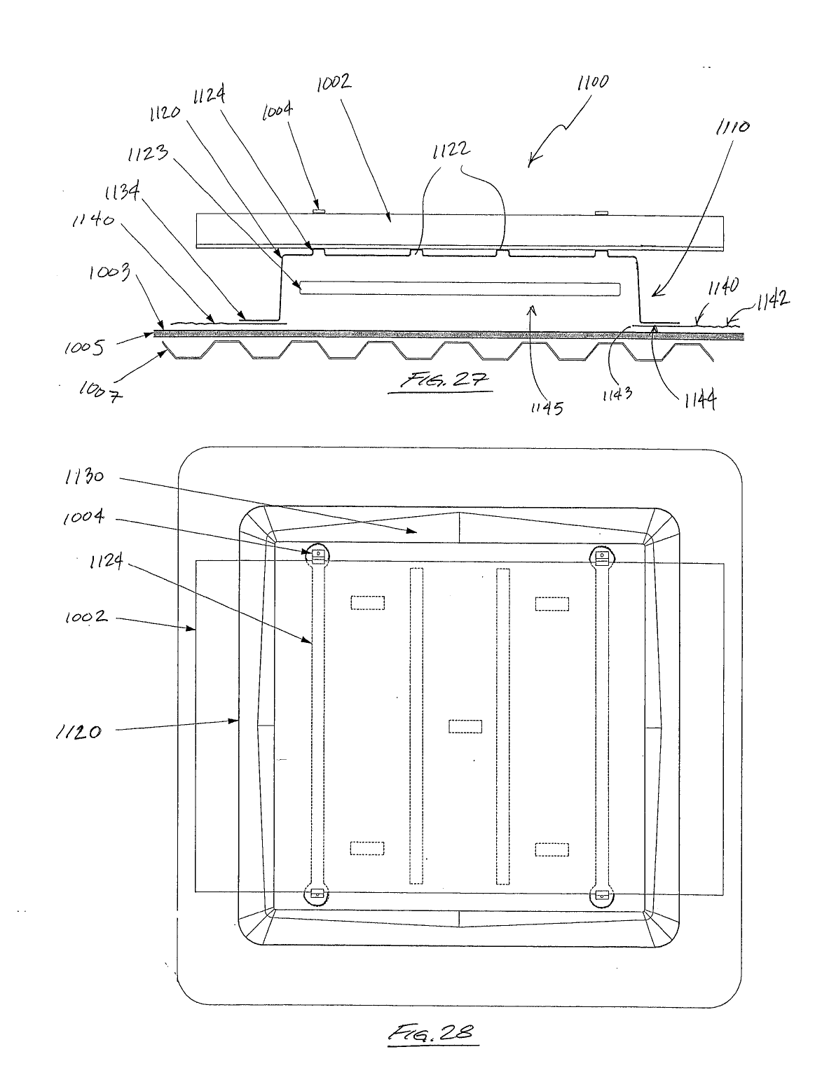

Referring to FIGS. 29 and 30, the assembly of photovoltaic module 1100 may be better appreciated. The photovoltaic cell 1002 is attached to the shell 1120 with a plurality of connectors, in this case, fastening clips 1152. Each fastening clip 1152 is secured to the upper surface 1132 with a fastener 1150 which extends through clip 1152 and through an insert 1154 that is located on the inside 1145 of the hollow shell 1120. Finally, fastener 1150 engages a cooperating fastener such as a nut 1156. The shell 1120 is secured to surrounding skirt membrane 1140 along an inner perimeter portion 1144 with heat welding, seam tape, or adhesive as indicated by 1158. Similarly, the outer perimeter portion 1142 of the surrounding membrane 1140 is adhered to the roof membrane 1003 with heat welding, seam tape, or adhesive as indicated by 1158. The photovoltaic cell may also be adhered to the shell with seam tape or liquid adhesive.

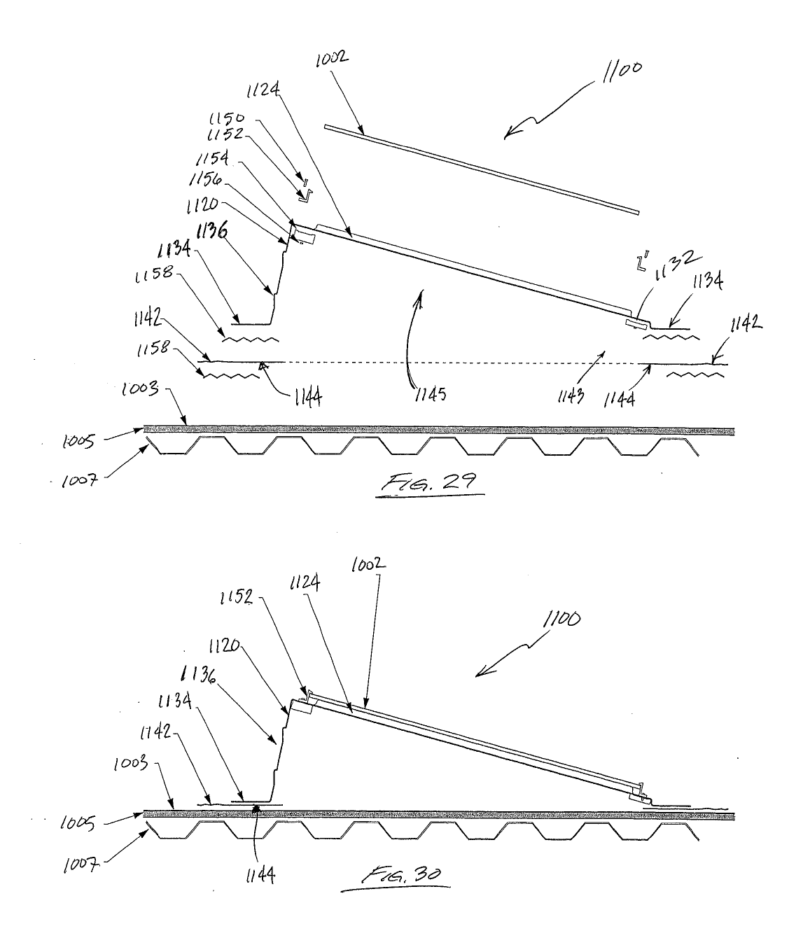

FIG. 31 illustrates an alternative arrangement for attaching the outer perimeter portion 1142 of membrane 1140 to a roof membrane 1003. In this case, a fastener 1162 extends through the roof membrane 1003 and the insulation board 1005 to engage the roof deck 1007. Fastener 1162 captures a washer 1160 against the roof membrane 1003. Washers 1160 are induction welded to membrane 1140 without penetrating the membrane. Each washer is bonded to the membrane with an induction welder. The washers include a heat activated adhesive. A suitable induction welder is approved by Firestone, Cralisle Syntec, Johns Manville, Sika® Sarnafil®, Durolast, Seaman Fibertite, and marketed as the Rhinobond System. The outer perimeter portion 1142 may also be adhered to the roof membrane 1003 with heat welding, seam tape, or adhesive as indicated by 1158. Bonding the outer perimeter portion 1142 to washers 1160 provides additional resistance to wind uplift.

FIG. 32 illustrates an isolation mount 1210 according to yet another exemplary embodiment. In this embodiment, the isolation mount 1210 comprises a wedge shaped shell 1220 and a surrounding skirt membrane 1240. In this case, the shell 1220 includes a ballast recess 1270. Ballast recess 1270 includes a floor 1272 and surrounding side walls 1274 and 1276 extending therefrom to join upper sloped surface 1232, which walls may be vented. In this embodiment, the floor 1272 is flush with flange 1234. The ballasted recess 1270 is designed to receive roofing ballast material such as gravel, pavers, rocks, sand, and the like. As such, the isolation mount 1210 is held against the roof surface to which it is mounted and may better resist wind uplift forces.

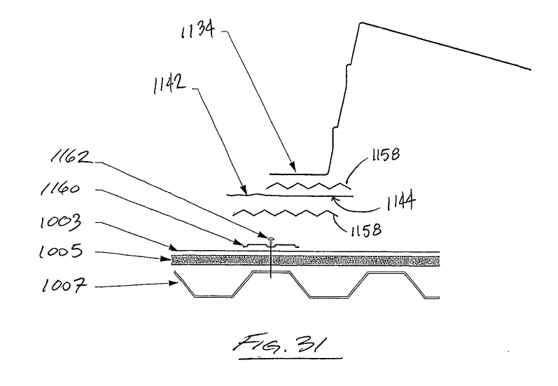

FIG. 33 illustrates an isolation mount 1310 according to another exemplary embodiment. In this case, the shell 1320 includes a plurality of horizontal and vertical ribs. As shown, the vertical ribs include four different styles 1324, 1325, 1326, and 1322.

Ribs 1324 include bosses which provide mounting holes as explained above. Shell 1320 also includes a plurality of horizontal ribs 1323. While a particular arrangement of horizontal and vertical ribs are shown here, other combinations of horizontal and vertical ribs on the upper surface as well as the side walls may be employed to increase the rigidity of the larger surfaces as desired.

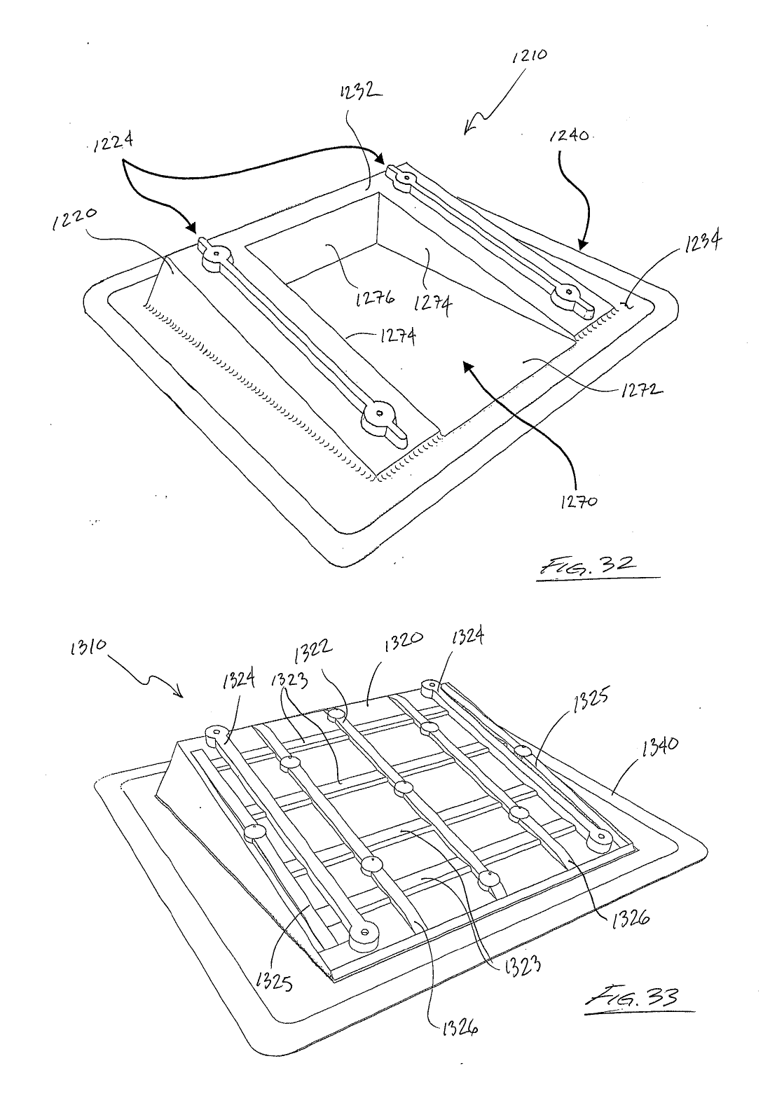

FIGS. 34-36 illustrate different embodiments of photovoltaic modules having varied numbers of isolation mounts and photovoltaic cells attached thereto. For example, FIG. 34 illustrates a photovoltaic module 1400 which includes a single isolation mount 1410 attached to surrounding skirt 1420 and supporting a single photovoltaic cell 1002. Alternatively, as shown in FIG. 35, photovoltaic module 1401 includes two isolation mounts 1411 which are attached to a single surrounding skirt membrane 1421. In this case, the two isolation mounts 1411 support a single photovoltaic cell 1002. It should be noted that the shape of the isolation mounts is not restricted to that of a square as shown in the previous embodiments. Instead, the isolation mounts may be in the form of rectangles, circles, triangles, and the like. For example, isolation mounts 1411 are rectangular in shape. Furthermore, the isolation mounts may be any polygon or random shape. In FIG. 36, photovoltaic module 1405 includes a plurality of isolation mounts. In this case, a combination of rectangular isolation mounts and square isolation mounts is used. Specifically, the photovoltaic module 1405 includes a pair of inner isolation mounts 1410 which are square in configuration. On the outside of those mounts are rectangular isolation mounts 1411. As shown, the isolation mounts 1411 and 1410 are joined to a single surrounding skirt membrane 1422. Accordingly, the entire module 1405 may be attached to a surface by adhering skirt membrane 1422 to the surface. In this case, three photovoltaic cells 1002 are supported on the isolation mounts as shown. While not specifically shown, it would be possible to mount multiple photovoltaic cells on a single isolation mount.

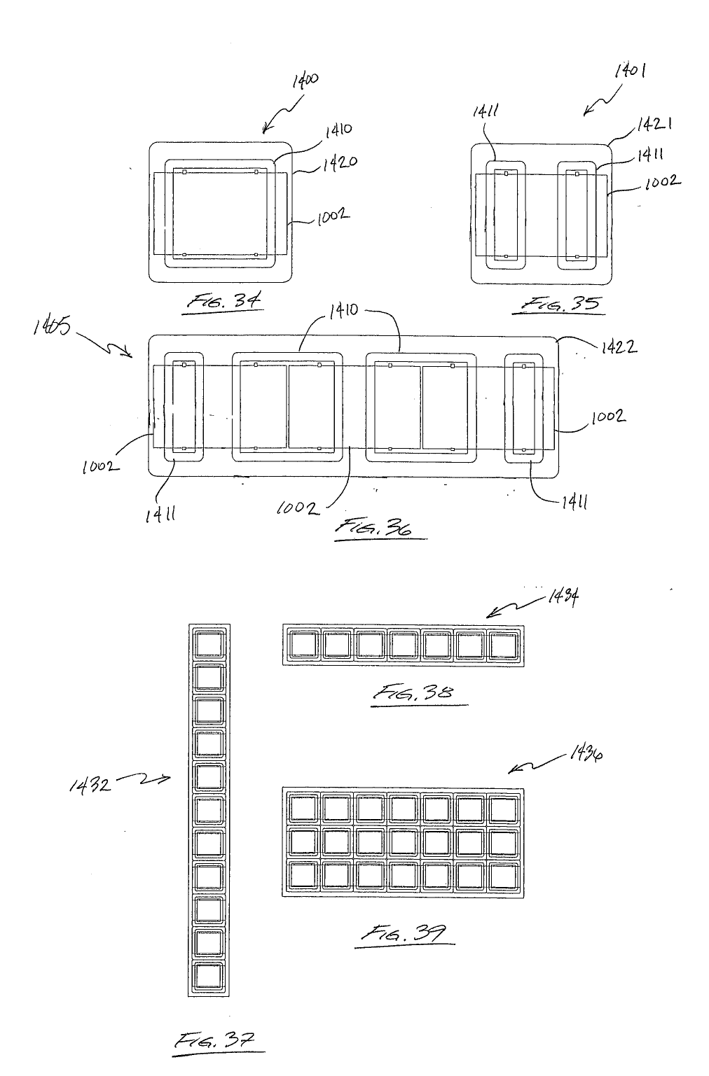

The isolation mounts may be arranged in various arrays as shown in FIGS. 37-39. For example, FIG. 37 illustrates a plurality of isolation mounts and corresponding photovoltaic cells arranged in a vertical array 1432. FIG. 38 illustrates a plurality of isolation mounts and corresponding photovoltaic cells arranged in a horizontal array 1434. FIG. 39 illustrates a plurality of isolation mounts and corresponding photovoltaic cells arranged in a two-dimensional array 1436 having seven columns and three rows. In this case, the three rows correspond to the width of a sheet or roll of roofing membrane material. Membrane is available in widths of 3 feet to 16 feet and in lengths of 100 feet to 400 feet or greater.

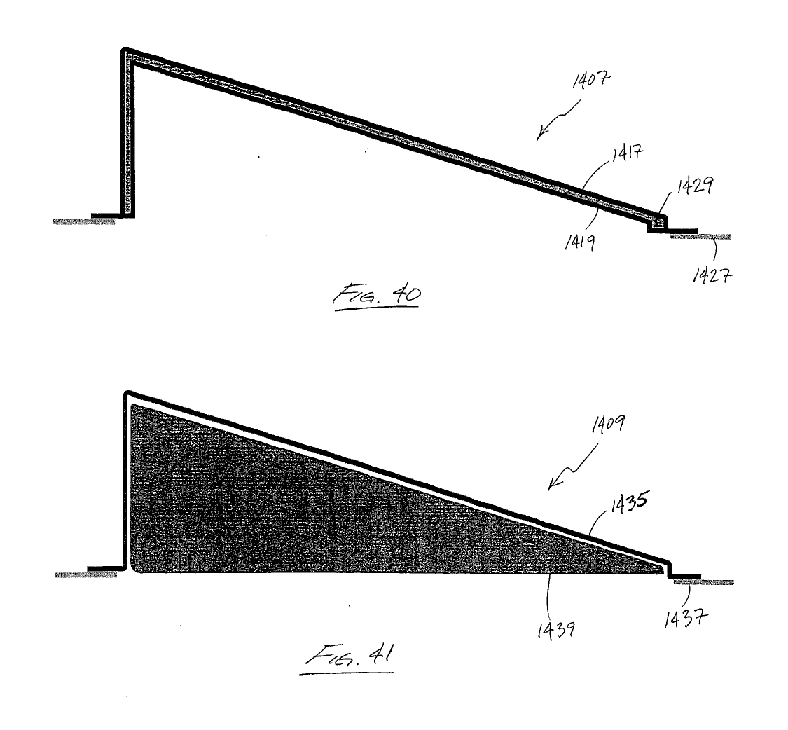

FIG. 40 illustrates an isolation mount 1407 according to another exemplary embodiment where the shell includes two thermoformed layers 1417 and 1419 with insulation material 1429 sandwiched therebetween. FIG. 41 illustrates an isolation mount 1409 having a single shell 1435 and an insulation insert 1439 which may be inserted just prior to installation on a roof or other surface.

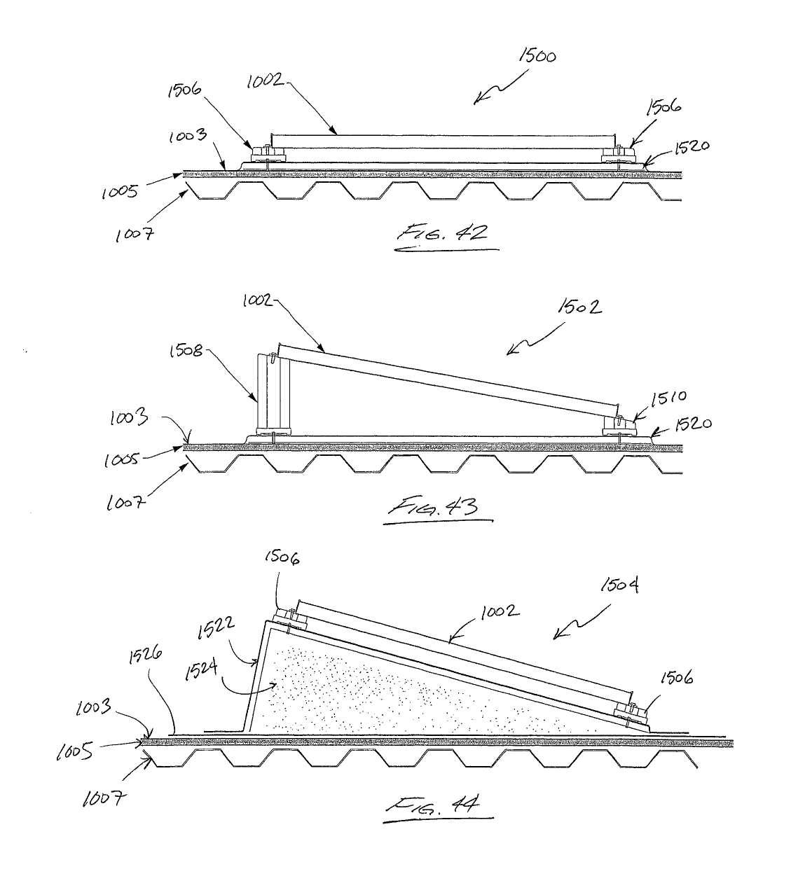

FIGS. 42-44 illustrate additional exemplary embodiments of a photovoltaic module, each incorporating a standoff or stanchion. In FIG. 42, the photovoltaic module 1500 includes a shell 1520, in this case having a flat upper surface which is attached to the roof membrane 1003 as explained above. In this embodiment, a plurality of equal length stanchions 1506 are secured to the shell 1520. The photovoltaic cell 1002 is attached to the stanchions 1506 with clips as explained above. FIG. 43 illustrates photovoltaic module 1502 which includes a photovoltaic cell 1002 mounted to a plurality of unequal length stanchions 1508 and 1510. As shown, the stanchions vary in length such that the photovoltaic cell 1002 is angled. FIG. 44 illustrates a photovoltaic module 1504 wherein the photovoltaic cell 1002 is mounted to a wedge-shaped shell 1522 via a plurality of equal length stanchions 1506. Also shown in this embodiment is an insulation insert 1524 which may be inserted into the isolation mount prior to installation on a roof or other surface.

Also contemplated herein are methods for deploying a photovoltaic system on a surface. The methods thus encompass the steps inherent in the above described structures and operation thereof. Broadly, one method comprises pre-assembling a plurality of isolation mounts. Each isolation mount includes a wedge shaped shell having an upper sloped surface and at least three sidewalls extending therefrom to join a surrounding flange. A skirt membrane is secured to the flange and includes a skirt membrane opening into a hollow region of the shell such that multiple isolation mounts may be stacked together. The method further comprises stacking the plurality of isolation mounts together, transporting the isolation mounts to a surface, such as a roof, and unstacking the isolation mounts. The skirts of the isolation mounts are secured to the surface and at least one photovoltaic cell is mounted to at least one of the isolation mounts. The method may further comprise filling a ballast recess formed in the isolation mount with roofing ballast.

The technology of the present application is applicable to all photovoltaic technologies including but not limited to individual cells or layered cells comprising of single crystalline silicon, polycrystalline silicon and amorphous silicon, gallium arsenide, copper indium diselenide, cadmium telluride, dye-sensitive and nano-technologies. Photovoltaic cells may be adhered or mechanically attached to the isolation mount. It is contemplated that one or more embodiments may further incorporate the use of thin film and organic photovoltaic technologies, developed as paint or film coatings instead of separate photovoltaic cells, laminates or modules.

Accordingly, the technology of the present application has been described with some degree of particularity directed to the exemplary embodiments. It should be appreciated, though, that the technology of the present application is defined by the following claims construed in light of the prior art so that modifications or changes may be made to the exemplary embodiments without departing from the inventive concepts contained herein.

What is claimed is:

1. An isolation mount, comprising:
a hollow shell having an upper surface and at least three sidewalls extending therefrom to join a surrounding flange; and
a skirt membrane having an inner perimeter portion secured to the surrounding flange and an outer perimeter portion extending away from the surrounding flange, wherein the inner perimeter portion defines a skirt membrane opening into a hollow region of the shell such that multiple isolation mounts may be stacked together.

2. An isolation mount according to claim 1, wherein the hollow shell is wedge shaped and the upper surface is sloped.

3. An isolation mount according to claim 2, wherein the inner perimeter portion is sealed to the surrounding flange.

4. An isolation mount according to claim 2, wherein the skirt membrane opening is congruent with the hollow region.

5. An isolation mount according to claim 2, wherein the upper sloped surface includes stiffening ribs.

6. An isolation mount according to claim 2, wherein the wedge shaped shell is thermoformed from a rigid plastic material.

7. An isolation mount according to claim 2, wherein the shell includes a ballast recess adapted to contain roofing ballast.

8. An isolation mount according to claim 2, configured to stack on another isolation mount.

9. An isolation mount according to claim 2, wherein the shell includes at least one cricket formation.

10. A photovoltaic module for use on the roof of a building, comprising:
an isolation mount, including:
a wedge shaped hollow shell having an upper sloped surface and at least three sidewalls extending therefrom to join a surrounding flange; and
a skirt membrane having an inner perimeter portion secured to the surrounding flange and an outer perimeter portion extending away from the surrounding flange; and
at least one photovoltaic cell secured to the isolation mount.

11. A photovoltaic module according to claim 10, including a plurality of isolation mounts secured to the skirt membrane.

12. A photovoltaic module according to claim 11, wherein the isolation mounts are arranged in an array.

13. A photovoltaic module according to claim 11, wherein at least one photovoltaic cell is secured to a plurality of isolation mounts.

14. A photovoltaic module according to claim 10, wherein the photovoltaic module is adhered to the isolation mount.

15. A photovoltaic module according to claim 10 including a plurality of connectors supported by the isolation mount and wherein the photovoltaic cell is secured by the connectors.

16. A photovoltaic module according to claim 10, wherein the inner perimeter portion is sealed to the surrounding flange.

17. A photovoltaic module according to claim 10, wherein the inner perimeter portion defines a skirt membrane opening into a hollow region of the shell.

18. A photovoltaic module according to claim 10, wherein the upper sloped surface includes stiffening ribs.

19. A photovoltaic module according to claim 10, wherein the wedge shaped shell is thermoformed from a rigid plastic material.

20. A photovoltaic module according to claim 10, wherein the shell includes a ballast recess adapted to contain roofing ballast.

21. A method for deploying a photovoltaic system on a surface, the method comprising:
pre-assembling a plurality of isolation mounts, each isolation mount including:
a wedge shaped shell having an upper sloped surface and at least three sidewalls extending therefrom to join a surrounding flange; and
a skirt membrane having an inner perimeter portion secured to the surrounding flange and an outer perimeter portion extending away from the surrounding flange, wherein the inner perimeter portion defines a skirt membrane opening into a hollow region of the shell such that multiple isolation mounts may be stacked together;
stacking the plurality of isolation mounts together;
transporting the isolation mounts to the surface;
unstacking the isolation mounts;
securing the skirts to the surface; and
mounting at least one photovoltaic cell to at least one of the isolation mounts.

22. The method according to claim 21, wherein each shell includes a ballast recess and including filling the ballast recesses with roofing ballast.

23. The method according to claim 21, including arranging the isolation mounts in an array.

24. The method according to claim 21, including thermoforming the shells from a rigid plastic material.
